(19) United States
(12) Patent Application Publication
(10) Pub. No.: US 2019/0034446 A1
(43) Pub. Date: Jan. 31, 2019

(54) AUTOMATED SEARCH METHOD, APPARATUS, AND DATABASE

(71) Applicant: WAAZON (HOLDINGS) LIMITED, Weeton Yorkshire (GB)

(72) Inventors: James MARTINEZ, Almeria (ES); Paris Val BAKER, Cornwall (GB)

(21) Appl. No.: 16/072,235

(22) PCT Filed: Jan. 26, 2017
(86) PCT No.: PCT/GB2017/050197

§ 371 Date: Jul. 24, 2018

(30) Foreign Application Priority Data
Jan. 29, 2016 (GB) 1601707.1

(51) Int. Cl. G06F 17/30

(52) U.S. Cl. CPC G06F 17/30106; G06F 17/3053; G06F 17/3087

(57) ABSTRACT

An automated method of providing search results to a user device comprises: receiving and/or monitoring at least one signal, the or each signal carrying at least one of text information and audio information; extracting, from each of a respective plurality of portions of the or each signal, at least a respective quantity of text corresponding to text and/or audio information carried by the respective portion of the signal; creating a plurality of files, each file corresponding to a respective one of said plurality of portions and comprising said respective quantity of text; storing said files in at least one database; and in response to receiving a search request from the user device, said search request including at least one search term or information indicative of said at least one search term: searching said at least one database to identify at least one matching file, the or each matching file being one of said files containing text corresponding to said at least one search term; and providing the user device with search results based on said at least one matching file.

### FIELD OF THE INVENTION

Certain aspects of the present invention relate to automated search methods, search apparatus, and search databases. In particular, although not exclusively, certain aspects and embodiments of the invention relate to improved automated methods of providing search results to user devices.

### BACKGROUND TO THE INVENTION

Automated search methods, and in particular computer implemented search methods accessed via the internet, are extremely well-known and are used or accessed by millions, if not billions, of people on a daily basis. A user will typically enter one or more search terms in a user interface provided on their user device (e.g. smartphone, tablet, computer, or any suitable piece of user equipment able to access the internet), a corresponding search request message is then transmitted from the user device, an automated search is performed, and corresponding search results are then generated and sent back to the user device for display to the user. Whilst these internet searches are very useful and provide search results quickly to the user, there are certain disadvantages associated with them. For example, these searches tend to be based on information provided on websites and web pages, and that information may in some cases be very old or out-dated. The search results are, additionally, limited to finding information that has been entered or uploaded onto the relevant website or web pages by the website or web page provider. Furthermore, in order to return search results of high relevance, a user typically has to perform a number of search iterations and/or type in a plurality of search terms. Further disadvantages associated with current search methods will be apparent to users from their own experiences, and from the following description.

Thus, there is a need to provide search methods and corresponding apparatus (i.e. systems) which can automatically provide users (or other originators of search requests) with more relevant search results and/or search results requiring reduced input (for example a reduced number of search terms typed in) by a user.

### SUMMARY OF THE INVENTION

It is an aim of certain embodiments of the invention to solve, mitigate or obviate, at least partly, at least one of the problems and/or disadvantages associated with the prior art. Certain embodiments aim to provide at least one of the advantages described below.

In accordance with a first aspect of the present invention there is provided an automated (e.g. computer implemented, which term includes cloud-implemented) method of providing search results (i.e. information) to (for) a user device, the method comprising:
receiving and/or monitoring at least one signal, the or each signal carrying at least one of text information and audio information;
extracting, from each of a respective plurality of portions of the or each signal, at least a respective quantity of text corresponding to text and/or audio information carried by the respective portion of the signal;
creating a plurality of files (which may also be described as database files), each file corresponding to a respective one of said plurality of portions and comprising said respective quantity of text;
storing said files in at least one database; and
in response to receiving a search request (message, signal) from the user device, said search request including at least one search term or information indicative of said at least one search term:
searching said at least one database to identify at least one matching file, the or each matching file being one of said files containing text corresponding to said at least one search term; and
providing the user device with search results (e.g. transmitting search results to, or for reception by, the user device) based on said at least one matching file.

Thus, rather than relying on the contents of websites or web pages managed by some other entity, the method provides the advantage that it creates and manages its own searchable database by receiving and/or monitoring at least one signal (which can come from a variety of sources, including sources not currently used for providing searchable information) and extracting searchable text from that signal or signals. Thus, the database may be arranged to hold files corresponding to very recently transmitted information, and hence the search results provided to the user device may be very current. The search method can therefore provide the user device with more relevant search results, in that they can relate to information freshly received and added to the database. Additionally, and/or alternatively, the method, by receiving and/or monitoring at least one signal and creating database files from those signals, can dramatically increase the number of information sources or information streams contributing to the body of searchable information. The method may thus receive, monitor, and generate searchable files from signals whose contents are not currently reflected in a website or web page based search.

In certain embodiments, each said portion corresponds to a respective period of time (time period).

In certain embodiments, each respective period of time has a length in the range 5 to 30 seconds.

In certain embodiments each respective period of time has a length in the range 10 to 15 seconds.

In certain embodiments each respective period of time has substantially the same length.

In certain embodiments, said plurality of portions of the or each signal are consecutive portions of the respective signal.

In certain embodiments, said consecutive portions are immediately consecutive portions.

Alternatively, in certain other embodiments, each adjacent pair of said consecutive portions are separated by a respective gap.

In certain embodiments, said at least one signal comprises at least one signal (i.e. at least one extracted signal) extracted from a satellite signal.

In certain embodiments, the method further comprises receiving said satellite signal from a satellite and extracting said at least one extracted signal from said satellite signal.

In certain embodiments, said at least one extracted signal comprises at least one signal comprising, corresponding to, or carrying: a channel, programme, feed, or data stream transmitting, for example broadcasting, news.

In certain embodiments, said at least one extracted signal comprises a plurality of extracted signals, extracted from at least one satellite signal.

In certain embodiments said plurality of extracted signals are extracted from a plurality of satellite signals.

In certain embodiments, the method further comprises receiving said plurality of satellite signals from a plurality of satellites and extracting said plurality of extracted signals from the plurality of satellite signals.

In certain embodiments, receiving said plurality of satellite signals comprises arranging a plurality of satellite signal receivers at a corresponding plurality of locations, each receiver arranged to receive a satellite signal from at least one respective satellite.

For example, the plurality of satellite signal receivers may be distributed around the world at appropriate locations so as to enable the system to monitor and capture information from the most significant broadcasters of news information around the world. By monitoring such broadcast signals from around the globe, the method is able to rapidly extract and create searchable files corresponding to broadcast news information, thereby enabling the search results provided to the user to be recent, relevant, and indicative of events occurring in the world at the current time, rather than the much older information typically retrieved from websites and webpages using existing search methods.

In certain embodiments, the method further comprises processing the or each extracted signal with (i.e. in, or using) a respective server to extract the respective quantities of text and create the respective plurality of files.

In certain embodiments, said at least one signal comprises at least one satellite signal.

In certain embodiments, said at least one satellite signal comprises a plurality of satellite signals.

In certain embodiments, said plurality of satellite signals are from a plurality of satellites.

In certain embodiments, the method further comprises receiving said plurality of satellite signals from a plurality of satellites.

In certain embodiments, receiving said plurality of satellite signals comprises arranging a plurality of satellite signal receivers at a corresponding plurality of locations, each receiver arranged to receive a satellite signal from at least one respective satellite.

In certain embodiments the method further comprises processing the or each satellite signal with (i.e. in, or using) a respective processor or processing means (e.g. a respective server) to extract the respective quantities of text and create the respective plurality of files.

In certain embodiments, the or each satellite signal receiver may be arranged to feed received signals to a respective plurality of servers, each arranged to process and extract text information and generate the corresponding searchable files for storage in the at least one database.

In certain embodiments, said at least one signal comprises at least one terrestrial signal.

Thus, in addition, or as an alternative, to generating searchable files from received satellite signals, certain embodiments of the invention may be arranged to receive and/or monitor at least one terrestrial signal. This provides the advantage that the number of information sources contributing to the searchable database or databases can be further increased, thereby contributing to the provision of search results of increased relevance to the user.

In certain embodiments, said at least one terrestrial signal comprises at least one signal: received via terrestrial radio transmission; received via terrestrial optical transmission; received via the internet; received via a website interface; received via SMS; or received via a mobile device application.

In certain embodiments, the method further comprises receiving said at least one terrestrial signal.

In certain embodiments, the method further comprises processing the or each terrestrial signal with (i.e. in, or using) a respective processor or processing means (e.g. a respective server) to extract the respective quantities of text and create the respective plurality of files.

In certain embodiments, said at least one signal comprises, corresponds to, or carries at least one of: a feed; a live feed; a web feed; a channel; a data stream; a live data stream; a broadcast; a live broadcast; a news broadcast; a TV news broadcast; a radio broadcast; a news feed; a radio or TV feed; a data feed; a programme; an internet feed; an RSS feed; a Twitter feed; a video and/or audio feed; a YouTube feed; a social networking feed; a website feed; a YouTube channel.

It will be appreciated that this list of suitable signals which may be received and/or monitored is by no means an exhaustive list. In its broadest sense, the method may receive and/or monitor any signal carrying text and/or audio information, and generate searchable files from such a signal. The above list of signals does, however, include signals which are commonly and currently used to convey news information rapidly around the globe, and so provide extremely useful sources of information for providing relevant search results to a user device.

It will also be appreciated that certain embodiments of the invention may utilise any combination of more than one signal from the above-mentioned list, or indeed all of these sources. The greater the number of signals being received and/or monitored to “feed” into the at least one database, the greater the body of up-to-date information that is searchable by the method.

In certain embodiments, said at least one signal carries at least one of: subtitles; subtitle information; programme information; images; image information.

In certain embodiments, said at least one signal comprises at least one live signal.

In certain embodiments, at least one said portion carries audio information and said extracting, from that portion, of at least a respective quantity of text comprises processing the audio information carried by that portion to generate said respective quantity of text (e.g. using voice recognition software).

Thus, in certain embodiments at least one of the signals carries information which is directly indicative of text information. In certain alternative embodiments, at least one of the signals may not carry text information as such, instead carrying audio information, such as a signal indicative of the spoken word. In contrast to previous search techniques, embodiments of the invention provide the advantage that transmitted audio information is thus able to contribute to the searchable database, as that audio information may be processed to generate corresponding searchable text. This may be achieved using voice recognition software, or other suitable computer programs. The signals carrying such audio information may be radio signals, video signals, TV signals, or any other such signal from which text may be extracted.

Thus, in certain embodiments said portion carrying audio information is a portion of an audio or video signal.

In certain embodiments, the method further comprises storing said portions of the or each signal before said extracting.

In certain embodiments storing said portions comprises storing each portion in a respective temporary file (which may also be described as an initial, or first file), and said extracting comprises extracting said respective quantity of text from the respective temporary file.

The storing of these respective temporary files may be in a suitably arranged server in certain embodiments.

In certain embodiments, the method further comprises deleting each temporary file after extracting said respective quantity of text.

In certain embodiments, each file (database file) comprises respective time information (e.g. a time stamp), said respective time information being indicative of a respective time at which the respective file was created or at which the respective portion was transmitted (e.g. from a source of the respective signal) or at which the respective temporary file was created.

Thus, in certain embodiments each respective file may contain information indicative of the “newness” or age of the text information it contains. Advantageously, methods embodying the invention are thus able to create and search a database in which text information is catalogued according to its “newness”, and hence search results may be provided to a user which are indicative of what is happening now in the world, or at least what has happened very recently.

In certain embodiments, the method further comprises identifying a plurality of matching files, and wherein providing the user device with search results comprises providing the user device with a respective search result corresponding to each of said matching files.

In certain embodiments, the method further comprises ranking the respective search results based at least in part on the respective time information of the respective matching files.

In certain embodiments, said ranking comprises applying a respective age weighting (which may be described as a respective time or newness weighting) to each search result, the respective age weighting decreasing with increasing age of the respective matching file (or, equivalently, the respective age weighting increasing, the more recently the respective matching file was created), said age being or corresponding to a time elapsed since said respective time.

For example, applying a respective age weighting may comprise applying a weighting factor equal, or proportional, to 1/(t0−tf), where t0 is a reference time (e.g. current time), and tf is the time at which the respective file was created or at which the respective portion was transmitted or at which the respective temporary file was created.

Thus, in certain embodiments of the invention, database files are catalogues according to some time criterion, indicative of the “newness” of the text information they contain. Search results may then be generated and provided to a user, ranked according to newness of the contained information, such that the user can be provided automatically with results corresponding to what is happening now, or has happened recently, without the user needing to input any further search terms. The method may thus be automatically biased towards providing the user with search results that relate to the entered search term and which also relate to recent events or updates.

It will be appreciated that in certain instances, a search request may include a place name. An ordinary keyword search according to the prior art would pick up articles relating to that place. However, in certain embodiments of the invention such search results may be further ranked according to a location associated with a source of the signal from which the text information has been extracted. For example, a person may enter search keywords “flood” and “York”. Certain embodiments of the present invention provide the advantage that search results may be presented to the user with a ranking based at least in part on information indicative of a distance between the publisher of the information and the subject specified in the keywords, namely “York” as will be appreciated from the following. Thus, certain embodiments of the invention are able to rank or prioritise recent results published by sources in, or close to York.

In certain embodiments, each said file (database file etc) comprises respective source location information indicative of at least one of:

a location (i.e. a source location) of, or associated with, a source (e.g. originator, creator, author, publisher, broadcaster, reporter) of the respective signal and/or contents (e.g. said text and/or audio information); and

a location (i.e. a source location) of, or associated with, a source (e.g. originator, creator, author, publisher, broadcaster, reporter) of text and/or audio information carried by the respective portion of the respective signal.

In certain embodiments, the respective source location information is contained in, or carried by the respective signal and the method further comprises extracting said respective source location information from the respective signal.

In certain alternative embodiments, the respective source location information is not explicitly contained in, or carried by, the respective signal and the method further comprises determining said respective source location information from respective identity information indicative of an identity of the respective source.

Thus, in certain embodiments, the respective identity information identity information is carried by the respective signal or the respective portion of the respective signal.

In certain embodiments, determining said respective source location information comprises using a database (or other information store) storing source location information indicative of a plurality of source locations and a corresponding plurality of source identities.

Thus, when the respective source location information is not carried by the respective signal or signal portion, the method may, for example, “look up” the respective source location information from a suitable database or other information store.

In certain embodiments, said source location information comprises a latitude and a longitude of the respective source location.

In certain embodiments, said search results are further based on said source location information.

Thus, the search results may be at least partly determined or tailored based on the source location information.

In certain embodiments, the method further comprises identifying a plurality of matching files, wherein providing the user device with search results comprises providing the user device with a respective search result corresponding to each of said matching files, and the method further comprising ranking the respective search results based at least in part on said source location information.

In certain embodiments, said search request includes a place name or information indicative of said place name, the method further comprises determining a place location of, or corresponding to, said place name, and said ranking of the respective search results based at least in part on said source location information comprises ranking the search results based at least in part on a distance between the place location and the respective source location.

In certain embodiments, wherein determining said place location comprises using a database (or other information store) storing information indicative of a plurality of place names and a corresponding plurality of place locations.

In certain embodiments, ranking the search results based at least in part on a distance between the place location and the respective source location comprises applying a first distance weighting (e.g. to each search result) which decreases the greater the distance between the place location and the respective source location.

In certain embodiments, said first location weighting comprises applying a weighting factor equal, or proportional, to 1/D1, where D1 is the distance between the place location and the respective source location.

Certain embodiments are concerned with the situation where a search request includes, or the search method establishes, a location of the user device without the user needing to specify that location, for example in the form of a further search term. In other words, certain embodiments address situations where a place name is not a search term contained in the search request. In such embodiments, the method may rank search results according to a closeness of a subject location to a user device location, and/or a closeness of a publisher of the respective signal, or content of the respective signal, to a location of the user device. For example, a user in Naburn (a village near York) may simply enter the search term or search word “flood”, and the search method embodying the invention may be arranged to provide recent search results that refer to floods in or near Naburn, and ideally searched results published by a source close to Naburn.

Thus, in certain embodiments the method further comprises determining a device location of, corresponding to, or associated with, the user device.

In certain embodiments, determining the device location from a signal received from the user device.

In certain embodiments, said signal received from the user device consists of or comprises the search request.

Thus, in certain embodiments, the search request (e.g. a search request message or signal) may comprise device location information indicative of a location of the user device (i.e. indicative of said device location).

In certain embodiments, the method comprises determining the device location from an IP address of the device.

In certain embodiments the method may determine the location of the user device using the user device's GPS, or other satellite navigation system. For example, it may utilise data from mobile phone tracking applications.

In certain embodiments, said device location comprises a latitude and a longitude.

In certain embodiments, said search results are further based on said device location.

In certain embodiments, the method further comprises identifying a plurality of matching files, wherein providing the user device with search results comprises providing the user device with a respective search result corresponding to each of said matching files, and the method further comprising ranking the respective search results based at least in part on said device location.

In certain embodiments, the method further comprises determining (ascertaining, identifying) a subject location of a subject of said respective quantity of text of each matching file, and wherein said ranking the respective search results based at least in part on said device location comprises ranking the respective search results based at least in part on a distance between the device location and the respective subject location.

In certain embodiments, ranking the respective search results based at least in part on a distance between the device location and the respective subject location comprises applying a second distance weighting factor equal, or proportional, to 1/D2, where D2 is a distance between the device location and the respective subject location.

In certain embodiments said subject location comprises a latitude and a longitude.

In certain embodiments, determining said subject location comprises determining said subject location before creating the respective file, and wherein the respective file comprises said subject location or information indicative of said subject location.

In certain embodiments, determining said subject location after creating the respective file, from the respective quantity of text.

In certain embodiments, determining said subject location comprises using a database (or other information store) storing information indicative of a plurality of subject locations and a corresponding plurality of words (e.g. place names).

Thus, in certain embodiments the method ranks search results according to distance between their subjects and the location of the user. Additionally, alternatively, further embodiments include the feature of ranking search results according to a closeness of a source of the respective signal, signal portion, or information contained within it, to the location of a user.

In certain embodiments, said search results are further based on a distance between the device location and the respective source location.

In certain embodiments, the method comprises identifying a plurality of matching files, wherein providing the user device with search results comprises providing the user device with a respective search result corresponding to each of said matching files, and the method further comprises ranking the respective search results based at least in part on a distance between the device location and the respective source location.

In certain embodiments, ranking the respective search results based at least in part on a distance between the device location and the respective source location comprises applying a third distance weighting factor equal, or proportional, to 1/D3, where D3 is a distance between the device location and the respective source location.

In certain embodiments, the method further comprises receiving said search request.

In certain embodiments, the device/user may have a set of predefined words that are automatically searched every 10 seconds or so by the method. In other words, the method may comprise receiving (e.g. via a user input) one or more specified words or search terms, and performing a series of searches automatically (e.g. at regular, predetermined, or varying intervals) based on the specified words. The method may be further arranged to provide alerts to the user, based on these results of the repeated searches. An alert may be sent, for example, when the search results change, i.e. after there has been an update. Thus, in certain embodiments a user may set up/provide a list of alerts (on their system/account). These words are thus stored, and whenever there is a related update on the database(s) the user is alerted.

Another aspect of the present invention provides an automated (e.g. computer implemented) method of generating search results, the method comprising:
receiving and/or monitoring at least one signal, the or each signal carrying at least one of text information and audio information;
extracting, from each of a respective plurality of portions of the or each signal, at least a respective quantity of text corresponding to text and/or audio information carried by the respective portion of the signal;
creating a plurality of files (which may also be described as database files), each file corresponding to a respective one of said plurality of portions and comprising said respective quantity of text;
storing said files in at least one database; and
in response to receiving a search request (e.g. a search request message or signal, optionally from a user device) including at least one search term or information indicative of said at least one search term:
searching said at least one database to identify at least one matching file, the or each matching file being one of said files containing text corresponding to said at least one search term; and
generating search results (i.e. information) based on said at least one matching file.

Thus, this method provides the same advantages as a method in accordance with the first aspect described above, in that a far greater number of information sources are able to contribute to the searchable database, and the search results may have increased relevance to a user or device from which the search request originates, without that search request necessarily having to contain further search terms as compared with searches performed using prior art methods and apparatus.

The method may, of course, further comprise a step of providing or transmitting the generated search results to a device (e.g. user device) from which the search request originates.

Also, features described above in relation to the first aspect may be employed in embodiments of this second aspect of the invention, with corresponding advantage.

Thus, certain embodiments of the invention comprise identifying a plurality of matching files, and wherein generating said search results comprises generating a respective search result corresponding to each matching file.

In certain embodiments, the method further comprises ranking the respective search results.

In certain embodiments, said ranking comprises ranking the respective search results according to at least one of:
time information indicative of a time associated with the respective file;

source location information indicative of a location (i.e. a source location) of, corresponding to, or associated with, a source (e.g. originator, creator, author, publisher, broadcaster, reporter) of the respective signal or respective portion and/or its contents (e.g. said text and/or audio information);

user device location information indicative of a location of, corresponding to, or associated with, a user device originating said search request; and

subject location information indicative of a location of, corresponding to, or associated with, a subject of said respective quantity of text.

In certain embodiments, the method further comprises transmitting said search results (e.g. in at least one search results message, i.e. a message or signal comprising, containing, or carrying said search results, or information indicative of said search results).

In certain embodiments, said search request is a search request from a user device, and said transmitting comprises transmitting said search results to, or for reception by, said user device.

In certain embodiments, the method comprises providing said search results to the user device.

In accordance with another aspect of the invention, there is provided an automated (e.g. computer implemented) method of generating search results, the method comprising, in response to receiving a search request (e.g. a search request message or signal) including at least one search term or information indicative of said at least one search term:
searching at least one database to identify at least one matching file, said at least one database comprising a plurality of files each comprising at least a respective quantity of text and respective time information indicative of a time of, associated with, or corresponding to creation of the respective file, the or each matching file being one of said files containing text corresponding to said at least one search term; and
generating search results (i.e. information) based on said at least one matching file.

By using at least one database which contains such respective time information (e.g. a time stamp) the method is thus able to provide search results corresponding to, tailored to, or biased towards information concerning events or postings that have occurred and/or have been reported recently, thereby enabling generation of search results which are of increased relevance to a user wishing to know what is happening now in the world.

It will be appreciated that methods of automatically generating search results in response to search requests, and indeed apparatus/systems implementing such methods, may also be described as search engines.

In certain embodiments, the method comprises identifying a plurality of matching files, and wherein generating said search results comprises generating a respective search result corresponding to each matching file.

In certain embodiments, the method further comprises ranking the respective search results.

In certain embodiments, said ranking comprises ranking the respective search results according to at least one of:
said time information;

source location information indicative of a location (i.e. a source location) of, corresponding to, or associated with, a source (e.g. originator, creator, author, publisher, broadcaster, reporter) of the respective file, a signal from which the file was derived, and/or its contents;

user device location information indicative of a location of, corresponding to, or associated with, a user device originating said search request; and

subject location information indicative of a location of, corresponding to, or associated with, a subject of said respective quantity of text.

Thus, embodiments of this aspect of the invention may incorporate any feature or combination of features as described above in relation to other aspects, with corresponding advantage. The search results may therefore be ranked according to at least one of: “newness” of the information; a closeness of the user device to a subject of the respective file; a closeness of the user device to a source of the respective file or its contents; a closeness of a source of the respective file or its contents to a subject of the respective file etc. Again, and as will be appreciated from the further description of the invention above and below, methods embodying the invention are thus able to generate and/or provide a user with search results that are both up-to-date, indicative of what is happening now or recently, and which are tailored to a current location of the user device without a user having to specify that location explicitly in a search request.

In certain embodiments, each of the plurality of files comprises respective source location information.

In certain embodiments, each of the plurality of files comprises respective subject location information.

In certain embodiments, the method further comprises receiving said search request from a user device.

In certain embodiments, the method further comprises transmitting or providing said search results to the user device.

Another aspect of the invention provides an automated method of creating, maintaining, updating, or managing a computer-searchable database, the method comprising:
receiving and/or monitoring at least one signal, the or each signal carrying at least one of text information and audio information;
extracting, from each of a respective plurality of portions of the or each signal, at least a respective quantity of text corresponding to text and/or audio information carried by the respective portion of the signal;
creating a plurality of files (which may also be described as database files), each file corresponding to a respective one of said plurality of portions and comprising said respective quantity of text; and
storing said files in at least one database.

Advantageously, this method is able to provide a database containing information gathered from a much wider range of sources than current databases employed in internet searches. Furthermore, the database contents are able to better reflect information regarding events that are occurring now, or have occurred in the very recent past. The database or databases so created may be searched by methods embodying the invention, or by search methods or search engines in accordance with the prior art, and yet still yield results that may have improved relevance to a user.

The method may further comprise storing said portions of the or each signal before said extracting.

In certain embodiments, storing said portions comprises storing each portion in a respective temporary file (which may also be described as an initial, or first file), and said extracting comprises extracting said respective quantity of text from the respective temporary file.

In certain embodiments, the method may further comprise deleting each temporary file after extracting said respective quantity of text.

In certain embodiments, each file (database file) comprises respective time information, said respective time information being indicative of a respective time at which the respective file was created or at which the respective portion was transmitted (e.g. from a source of the respective signal) or at which the respective temporary file was created.

In certain embodiments, each file further comprises at least one of:
respective source location information indicative of a location (i.e. a source location) of, associated with, or corresponding to, a source (e.g. originator, creator, author, publisher, broadcaster, reporter) of the respective signal, respective portion, and/or its contents (e.g. said text and/or audio information); and
respective subject location information indicative of a location of, corresponding to, or associated with, a subject of said respective quantity of text.

Thus, the database may be searched by methods embodying the invention, or by methods in accordance with the prior art, and yet still yield results which are tailored to give the user an indication of events or postings occurring in the recent past, and which are associated with a location close to a current location of the user, and/or published by a source close to the current location of the user and/or close to a location of a subject of a database file or search request.

Another aspect of the invention provides an automated method of providing search results to a user device, the method comprising:
receiving a search request from a user device, the search request comprising information indicative of at least one search term and a location of the user device;
searching at least one information source for search results based at least in part on the at least one search term and the location of the user device; and
providing said search results to the user device.

Another aspect of the invention provides an automated method of providing search results to a user device, the method comprising:
receiving a search request from a user device, the search request comprising information indicative of at least one search term;

determining a location of the user device;
searching at least one information source for search results based at least in part on the at least one search term and the location of the user device; and
providing said search results to the user device.

Another aspect of the invention provides an automated method of providing search results to a user device, the method comprising:
receiving a search request from a user device, the search request comprising information indicative of at least one search term;
searching at least one information source for search results based at least in part on the at least one search term and an age (or equivalently, a “newness”) of the information; and
providing said search results to the user device.

Another aspect of the invention provides an automated method of providing search results to a user device, the method comprising:
receiving a search request from a user device, the search request comprising information indicative of at least one search term;
searching at least one information source for search results based at least in part on the at least one search term and a location associated with the search results; and
providing said search results to the user device.

It will be appreciated that automated methods embodying the invention are not limited to methods in which matching files are those containing exactly the same text as one or more of the search terms. Additionally, rather than finding one or more matching files as such, methods embodying the invention may search one or more databases and provide a user device with search results based on at least one of: a search term; an age or “newness” of an entry in a database; a location of, or associated with, a user device; and information indicating the location of the source of, or associated with, a database entry.

Another aspect of the invention provides an automated (e.g. computer implemented) method of generating search results, the method comprising, in response to receiving a search request (e.g. a search request message or signal) including at least one search term or information indicative of said at least one search term:
searching at least one database storing a plurality of files each comprising at least a respective quantity of text and respective time information indicative of an age of the respective file (e.g. information indicative of a time of, associated with, or corresponding to creation of the respective file); and
generating search results (i.e. information) based on said at least one search term and said time information.

In certain embodiments, said search results are further based on at least one of:

source location information indicative of a location (i.e. a source location) of, corresponding to, or associated with, a source (e.g. originator, creator, author, publisher, broadcaster, reporter) of the respective file, a signal from which the file was derived, and/or its contents;

user device location information indicative of a location of, corresponding to, or associated with, a user device originating said search request; and

subject location information indicative of a location of, corresponding to, or associated with, a subject of said respective quantity of text.

In certain embodiments, said extracting further comprises extracting a respective image or respective image data from at least one said portion, the respective image or respective image data then being comprised in the respective file.

Another aspect of the invention provides apparatus adapted (or, equivalently, arranged or configured) to implement a method in accordance with any of the above described aspects or embodiments.

Another aspect of the invention provides apparatus (e.g. an automated system) operable (arranged) to provide search results to (for) a user device (user equipment), the system comprising:

signal receiving and/or monitoring means (e.g. at least one signal monitor, unit, or module, or signal monitoring server) arranged to receive and/or monitor at least one signal carrying at least one of text information and audio information;
extraction means (e.g. text extraction means, or at least one text extractor, unit, or module, or text extracting server) arranged in communication with the signal receiving and/or monitoring means and further arranged to extract, from each of a plurality of portions of the or each signal, at least a respective quantity of text corresponding to text and/or audio information carried by the respective portion of the signal;
file creating (or generating) means (or at least one file creator, unit, or module, or file creating server) arranged in communication with the extraction means and further arranged to create a plurality of files, each file corresponding to a respective one of said plurality of portions and comprising said respective quantity of text;
file storage means (e.g. at least one file store, memory, database, unit or module, or file storage server) arranged in communication with the file creating means and arranged to store said files; and
search request processing means (e.g. at least one search request processor, unit, or module, or search request processing server) arranged to: receive a search request from the user device, said search request including at least one search term or information indicative of said at least one search term; search said file storage means for at least one matching file, the or each matching file being one of said files containing text corresponding to said at least one search term; and transmit (send) search results to (or for reception by) the user equipment, said search results being based on said at least one matching file.

Another aspect of the invention provides apparatus operable to generate search results automatically in response to receiving a search request, the apparatus comprising:

signal receiving and/or monitoring means (e.g. at least one signal monitor, unit, or module, or signal monitoring server) arranged to receive and/or monitor at least one signal carrying at least one of text information and audio information;
extraction means (e.g. text extraction means, or at least one text extractor, unit, or module, or text extracting server) arranged in communication with the signal receiving and/or monitoring means and further arranged to extract, from each of a plurality of portions of the or each signal, at least a respective quantity of text corresponding to text and/or audio information carried by the respective portion of the signal;
file creating means (or at least one file creator, unit, or module, or file creating server) arranged in communication with the extraction means and further arranged to create a plurality of files, each file corresponding to a respective one of said plurality of portions and comprising said respective quantity of text;
file storage means (e.g. at least one file store, memory, database, unit or module, or file storage server) arranged in communication with the file creating means and arranged to store said files; and
search request processing means (e.g. at least one search request processor, unit, or module, or search request processing server) arranged to: receive a search request (e.g. from a user device), said search request including at least one search term or information indicative of said at least one search term; search said file storage means for at least one matching file, the or each matching file being one of said files containing text corresponding to said at least one search term; and generate search results based on said at least one matching file.

Another aspect provides a computer program (i.e. software, or Application software; an “app”) arranged such that, when executed by a user device, the user device provides a user interface (UI) for interacting with a method, apparatus, or system in accordance with any other embodiment or aspect of the invention. The software may be further arranged such the user device obtains and transmits location information indicative of a location of the user (i.e. of the user device), for example automatically, when the UI received a search request input from a user. To do this, the software may interact with one or more other apps or software running on the device (e.g. a Global Positioning System, GPS, app or other such app providing location information via interaction with a satellite navigation system).

Another aspect provides software (application software) arranged such that, when executed by a user device, the user device provides a user interface for inputting a search request comprising at least one search term, and transmits a search request message, containing said search term(s) or information indicative of said search term(s), to a search engine, in response to a user inputting said search request, said software being further arranged such that the user device obtains location information indicative of a location of said user device and transmits said location information to said search engine. The software may be further arranged such that the user device transmits said location information in said search request message, or in a separate message.

The software may be further arranged such that the user device obtains said location information in response to a user inputting said search request.

Another aspect provides a user device on which is installed software in accordance with any other aspect or embodiment.

Another aspect provides a database created, updated, maintained, and/or managed by a method, apparatus, or system in accordance with any other aspect or embodiment.

Another aspect provides a computer-searchable database storing a plurality of files, each file comprising a respective quantity of text, or information indicative of said quantity of text, and at least one of:

respective time information indicative of a respective time at which the respective file was created;
respective source location information indicative of a location (i.e. a source location) of, associated with, or corresponding to, a source (e.g. originator, creator, author, publisher, broadcaster, reporter) of a respective signal or signal portion from which the respective quantity of text was extracted; and
respective subject location information indicative of a location of, corresponding to, or associated with, a subject of said respective quantity of text.

Another aspect provides a search engine arranged to implement a method in accordance with any preceding claim. Thus, the search engine may be arranged to perform searching (based on a search request) and ranking of search results in accordance with any one or more of the techniques described in this specification. Another aspect provides apparatus arranged to provide such a search engine.

It will be appreciated that embodiments of these apparatus aspects of the invention may incorporate apparatus features corresponding to method features described above in relation to any method aspect or embodiment, with corresponding advantage.

Thus, in certain embodiments, said at least one signal comprises at least one satellite signal and the signal receiving and/or monitoring means comprises at least one satellite receiver arranged to receive at least one said satellite signal.

In certain embodiments, the signal receiving and/or monitoring means comprises a plurality of satellite signal receivers at a corresponding plurality of locations, each receiver arranged to receive a satellite signal from at least one respective satellite.

In certain embodiments, said plurality of satellite signal receivers comprises at least four satellite signal receivers distributed around the world.

In certain embodiments, the text extraction means comprises a respective processor (or processing means, or server) arranged to extract the respective quantities of text from each received satellite signal, and optionally create the respective plurality of files.

In certain embodiments, said at least one signal comprises at least one terrestrial signal, and the signal receiving and/or monitoring means comprises at least one terrestrial signal receiver (e.g. server) arranged to receive said at least one terrestrial signal.

In certain embodiments, the extraction means comprises a respective processor (or processing means, or server) arranged to extract the respective quantities of text from each received terrestrial signal, and optionally create the respective plurality of files.

In certain embodiments, at least one of said signal receiving and/or monitoring means, extraction means, file creating means, file storage means, and search request processing means of apparatus in accordance with any one of claims 98 to 105.

Another aspect of the invention provides a method of automatically providing search results to a user device (equipment) (in response to receiving a search request from the user device), the method comprising:
automatically receiving and/or monitoring at least one signal (e.g. a data stream), said signal carrying at least one of text information and audio information;
automatically extracting from each of a plurality of portions (segments) of said signal (for example each portion of said signal corresponding to a respective time interval/period/segment) at least a respective quantity of text corresponding to at least a portion of the respective text and/or audio information carried by the respective portion of the signal;
automatically creating a plurality of files, each file corresponding to a respective one of said portions of said signal and comprising said respective quantity of text;
automatically storing said files in at least one database;
receiving a search request from a user device, said search request including at least one search term or information corresponding to said at least one search term;
automatically searching said at least one database for at least one of said files containing text corresponding to said at least one search term (in other words, automatically searching for at least one matching file); and
automatically transmitting search results to the user device, said search results being based on said at least one of said files containing text corresponding to said at least one search term (i.e. based on said at least one matching file, or, in other words, based on information contained in the at least one matching file).

Another aspect of the invention provides apparatus for automatically providing search results to user equipment, the apparatus comprising:
storage means:

signal receiving and/or monitoring means arranged to receive and/or monitor at least one signal, said signal carrying at least one of text information and audio information;
signal processing means arranged in communication with the signal receiving and/or monitoring means and the storage means, and further arranged to extract from each of a plurality of portions of said signal at least a respective quantity of text corresponding to at least a portion of the respective text and/or audio information carried by the respective portion of the signal, create a plurality of files, each file corresponding to a respective one of said portions of said signal and comprising said respective quantity of text, and store said files in said storage means; and
search request processing means arranged to: receive a search request from the user equipment, said search request including at least one search term or information corresponding to said at least one search term; search said storage means for at least one of said files containing text corresponding to said at least one search term: and transmit (send) search results to the user equipment, said search results being based on said at least one of said files containing text corresponding to said at least one search term.

Another aspect of the invention provides an automated (e.g. computer implemented) method of providing search results to a user, the method comprising:
receiving and/or monitoring at least one signal, said signal carrying at least one of text information and audio information;
extracting from each of a plurality of portions of said signal at least a respective quantity of text corresponding to at least a portion of the respective text and/or audio information carried by the respective portion of the signal;
creating a plurality of files, each file corresponding to a respective one of said portions of said signal and comprising said respective quantity of text;
storing said files in at least one database; and
in response to receiving a search request from a user, said search request including at least one search term:
searching said at least one database for at least one of said files containing text corresponding to said at least one search term; and
providing the user with search results based on said at least one of said files containing text corresponding to said at least one search term.

Further aspects and embodiments of the invention (which may be employed independently, or in combination with one or more of the other described aspects and embodiments of the present invention) relate to methods and apparatus for generating marked-up text, and the subsequent display of, and extraction of, words from the amended marked-up text via user interaction with the displayed amended marked-up text, for example to extract and insert words, irrespective of their language, in search requests (e.g. in a search text box or window of a user interface) for transmission to a search system/engine.

Thus, certain aspects and examples of the present invention enable displayable text of marked-up text to be identified and subsequently indicated, and words within the displayable text divided into textual elements. These textual elements may then be extracted from the displayable text and made the subject of a search via user selection. Textual elements therefore become directly searchable, thus enabling a user to easily and efficiently perform searches based on displayed text, whether it be text forming part of a webpage, subtitles, video commentary or comments and so forth, without the use of hyperlinks or copying and pasting of displayed text.

In accordance with one aspect of the present invention, a method for generating marked-up text is provided, the method comprising receiving computer readable marked-up text, identifying displayable text included in the computer readable marked-up text, identifying one or more textual elements included in the displayable text, and generating amended computer readable marked-up text including the displayable text and one or more indicators indicating the identified textual elements.

In certain embodiments, the displayable text comprises one or more words and a textual element is formed from one or more words, and one or more predetermined words are not permitted to form a textual element, and the identifying one or more textual elements includes dividing the words of the displayable text that are not one of the one or more predetermined words into the one or more textual elements according to one or more predetermined rules. By virtue of excluding certain words from forming textual elements, the probability of textual elements relating to words with comparatively little meaning such as certain prepositions for example is reduced and the likelihood that textual elements are terms a user wishes to search increased.

In certain embodiments, the method further comprises displaying the displayable text of the amended computer readable marked-up text, receiving user input with respect to the displayed text, determining, based on the indicators, whether the user input is with respect to a textual element of the displayed text, and displaying, in response to receiving user input with respect to a textual element of the displayed text, an indication of the respective textual element. By virtue of this, the textual elements are indicated to a user, so that they may easily identify the textual elements available to be selected.

In certain embodiments, generating the amended computer readable marked-up text includes inserting the indicators into the received computer readable marked-up text.

In certain embodiments the indicators include one or more predetermined tags.

In certain embodiments, generating the amended computer readable marked-up text includes enclosing each identified textual element with a pair of the predetermined tags. By virtue of identifying textual elements with predetermined tags, the textual elements may be recognised when the displayable text is being rendered for display, thus not requiring manual identification of textual elements as is would be the case with hyperlinks or manual copying and pasting.

In certain embodiments, the amended computer readable marked-up text includes display layout information and the displaying the amended computer readable marked-up text includes displaying the displayable text in accordance with the display layout information.

In certain embodiments, the computer readable marked-up text is in the HyperText Markup Language, HTML.

In certain embodiments, the amended computer readable marked-up text is in the HTML.

In certain embodiments, the tags are non-standard HTML tags.

In certain embodiments, the marked-up text is included in closed-caption information.

In certain embodiments, in response to receiving user input with respect to a textual element of the displayed text, inputting the respective textual element into a search engine. By virtue of this, terms displayed via the use of marked-up text may be simply and easily input into a search engine via a single user interaction without the use of hyperlinks or manual copying and pasting.

In certain embodiments, the marked-up text is included in an HTML file and the amended marked-up text is included in an amended HTML file, and one or more of the determining whether the user input is with respect to a textual element of the displayed text, the displaying an indication of the respective textual element, and the inputting the respective element into a search engine are performed by client-side executable code included in the amended HTML file.

In certain embodiments the client-side executable code is JavaScript.

In accordance with another aspect of the present invention, a user device for displaying text of marked-up text is provided, the user device comprising a receiver configured to receive marked-up text, and a processor configured to identify displayable text included in received computer readable marked-up text, identify one or more textual elements included in the displayable text, and generate amended computer readable marked-up text including the displayable text and one or more indicators indicating the identified textual elements.

The user device may be further adapted to implement one or more of the other aspects or embodiments of the invention.

In certain embodiments, the displayable text comprises one or more words and a textual element is formed from one or more words, and one or more predetermined words are not permitted to form a textual element, and wherein the identifying one or more textual elements includes dividing the words of the displayable text that are not one of the one or more predetermined words into the one or more textual elements according to one or more predetermined rules.

In certain embodiments, the user device further comprises a display configured to display the displayable text of the amended computer readable marked-up text, and a user input interface configured to receive user input with respect to the displayed text, and wherein the processor is configured to control the display to display the displayable text, detect a user input received through the user interface, determine, based on the indicators, whether the received user input is with respect to a textual element of the displayed text, and, in response to receiving user input with respect to a textual element of the displayed text, control the display to display an indication of the respective textual element, and extract the words of the respective textual element.

In certain embodiments, the processor is configured, in response to receiving user input with respect to a textual element of the displayed text, to input the words of the respective textual element into a search engine.

In accordance with another aspect of the present invention, a server for providing marked-up text to a user is provided, the server comprising a receiver configured to receive marked-up text, a processor configured to identify displayable text included in received computer readable marked-up text, identify one or more textual elements included in the displayable text and generate amended computer readable marked-up text including the displayable text and one or more indicators indicating the identified textual elements, and a transmitter configured to transmit the amended computer readable marked-up text to the user device. The server may, for example, be further adapted to implement one or more of the other aspects or embodiments of the invention.

It will be appreciated from the above that any of the above described features of any aspect of the invention may be employed in any other aspect of the invention with corresponding advantage. Furthermore, aspects and embodiments of the invention may be combined. For example, a user device may be adapted to execute an app which provides a user interface embodying the touch word aspect of the invention, to facilitate entry of keywords (i.e. search terms) without the need for typing, and which also automatically obtains location information of the location of the user device when a search request is input, such that that location information may also be sent to a remote search engine and so enable search results to be provided that are tailored to the user's current location.

It will also be appreciated that the numerous advantages associated with aspects and embodiments of the present invention include, but are not limited to, the following;
providing a user with search results of improved relevance automatically;
using new and/or additional information sources to contribute to, and populate, at least one searchable database;
using time information associated with database entries to provide initiators of search requests with results better indicative of current or recent events related to their search terms;
use of location information associated with subjects of database files and/or sources of corresponding information to provide the originator of the search request automatically with search results tailored to the originator's location, without the originator needing to specify their location in the search request; dramatically increasing the number of information sources or information streams feeding into one or more searchable databases to enable searches to be performed that automatically provide users with results of increased relevance;
use of new information sources to searchable databases, in particular use of newsfeeds and/or social media feeds, such that search results may be generated which are of increased relevance to the user in terms of being indicative of recent events and/or events in the locality of the user; and
searching is facilitated, in that search terms (words) may be selected and placed in search requests without the need for typing, simply by touching the word (in whatever language) displayed on a touch screen (e.g. of the user device).

It will be appreciated from the following description that, in certain embodiments of the invention, features concerning the graphic design of user interfaces are combined with interaction steps or means to achieve a technical effect.

Certain embodiments aim to achieve the technical effect of lowering a burden (e.g. a cognitive, operative, operational, operating, or manipulative burden) of a user when performing certain computer or device interactions.

Certain embodiments aim to achieve the technical effect of providing a more efficient man-machine (user-machine) interface.

Another aspect of the invention provides a computer program comprising instructions arranged, when executed, to implement a method and/or apparatus in accordance with any one of the above-described aspects. A further aspect provides machine-readable storage storing such a program.

### BRIEF DESCRIPTION OF DRAWINGS

Embodiments of the present invention will now be described with reference to the accompanying drawings, of which:

FIG. 1 is a flowchart illustrating steps in a method embodying the invention;

FIG. 2 is a flowchart illustrating steps in another method embodying the invention;

FIG. 3 is a schematic representation of signals which may be received and monitored in embodiments of the invention;

FIG. 4 is a schematic representation of further signals which may be received and monitored in embodiments of the invention;

FIG. 5 is a schematic representation of a system (i.e. apparatus) embodying the invention;

FIG. 6 is a diagram illustrating further apparatus embodying an aspect of the present invention;

FIG. 7 is a schematic representation of another system embodying one aspect of the invention;

FIG. 8 is a schematic representation of another system embodying an aspect of the invention;

FIG. 9 illustrates a distribution of satellites whose signals may be received and monitored in embodiments of the invention;

FIG. 10 is a flowchart illustrating steps in another method embodying an aspect of the invention;

FIG. 11 is a flowchart illustrating steps in another method embodying an aspect of the invention;

FIG. 12 is a flowchart illustrating steps in another method embodying an aspect of the invention;

FIG. 13 illustrates steps in another method embodying an aspect of the invention;

FIG. 14 is a flowchart illustrating steps in another method embodying an aspect of the invention;

FIG. 15 is a flowchart illustrating steps in another method embodying an aspect of the invention;

FIG. 16 illustrates user equipment running an app in accordance with another aspect of the invention;

FIG. 17 provides an illustration of a flow diagram of a text selection method in accordance with an example of the present invention;

FIG. 18 provides an illustration of text selection method in accordance with an example of the present invention;

FIG. 19 provides an illustration of a flow diagram of a method for generating amended computer readable marked-up text in accordance with an example of the present invention;

FIG. 20 provides an illustration of a flow diagram of a method for identifying textual elements of displayable text of marked-up text;

FIG. 21 provides an illustration of a flow diagram of text selection method in accordance with an example of the present invention;

FIG. 22 provides an illustration of a flow diagram of a method for generating amended computer readable marked-up text from a received webpage in accordance with an example of the present invention;

FIG. 23 provides an illustration of communications exchanges that may take place between a server and a user device when a method in accordance with an example of the present invention is performed;

FIG. 24 provides an illustration of communications exchanges that may take place between a server and a user device when a method in accordance with an example of the present invention is performed;

FIG. 25 provides a schematic illustration of a server in accordance with an example of the present invention; and

FIG. 26 provides a schematic illustration of a user device in accordance with an example of the present invention.

### DETAILED DESCRIPTION OF EMBODIMENTS OF THE INVENTION

It will be appreciated that the following embodiments and aspects may be arranged to implement any of the methods, apparatus, and systems described above in the summary of the invention. Before describing these embodiments in detail, however, we set out further background to the invention, as follows:

Today's world of the Internet is very different to what it was 15 years ago. Google's birthday is September 27 and it is 16 years old this year, however very little in the world of search has changed. Google's original algorithms were based on word density and how many links pointed at a site. This was used to work out how a site is to be ranked. Although this algorithm now looks at over 350 signals basically the web is still the sameToday's world of the Internet is about the NOW. Facebook and twitter are live information systems as is Whatsapp, Skype and many other live applications. The huge user base and addiction to these live systems, especially Facebook and Twitter, is proof how relevant live information is to the user. Interestingly neither of these platforms is based on a static Websites or the indexing of WebPages.

It was apparent to the present inventors that Google's many updates and changes have not improved the live experience of the Web at all. Moreover, the popularity of Facebook and Twitter shows that they are entirely missing the point. People are not “engaged” in an old web based search system that does not tell them what is happening in the world right now. Google is fantastic if you want to know some facts about something historic. However the engagement in the Search engine its self is minimal, you carry out a search, click a link and leave Google, going to the site with the relevant information on. Meanwhile the populous is engaged in Twitter and Facebook. Google Bing and Yahoo, to name a few, will always have place if you need to know facts written in a webpage, but whichever way you look at these search systems are still searching through a library of web pages . . . moreover they are all searching the same library!

The present inventors thus determined that something completely new was required, not a web based system that crawls through millions of websites. What is required is a complete re-think on the way search has been approached for the last 15+years. There is a requirement for a new ranking algorithm that reflects the needs of today's more impatient users. New data sources and previously un-thought of, or yet unharnessed, data sets are also required. These new data sets and the new ranking system have to reflect the ranking of results, according to criteria that is relevant to the user! Let us think about that again “criteria that is relevant to the user” not criteria that Google thinks is relevant. This new algorithm also needs to be embedded into a revolutionary user interface that just works with today's touch devices. This system needs to provide live data that is highly relevant to the user, addictive and all consuming. Indeed this new interface itself becomes the only method that they want to see data. This system is not just an algorithm it is a whole new way of presenting data. It is as revolutionary as the iPhone was compared to an old flip banana phone.

To demonstrate this idea, we provide a few examples. These are extreme examples because this system will provide faster and more accurate information depending on its importance to the user.

1) So let us assume for a while that you live in the south west of England and suddenly floods are hitting the promenade in Penzance and river levels are rising fast. These floods are flash floods with rivers breaking their banks. You are worried because you need to know right now what is going on. You carry out a search on Google and the results will typically be useless to you. This is because the news of the floods has to be written and uploaded to the Web. This data then needs to be indexed and then ranked by Google. So the age of the data is a problem, maybe the results will talk about floods that started 200 miles away a few hours ago, or even last year's floods, all irrelevant to you, as its too old or too far away. So you switch on the TV to see what they are reporting and you are faced with trying to wade through all the channels to find some local news, you can't exactly search for the words “Penzance Floods on your TV” it is a one-way information street, it broadcasts to you. There is no way you are going to find what you are looking for on the Internet or on TV unless you stumble across a live local radio or TV broadcast. (This actual incident happened to one of the present inventors)

2) You just want to know what the latest weather report is. Well, unless you specify exactly where, Google or Bing will currently return a top result from weather.com, this state's “The Weather Channel and weather.com provide a national and local weather forecast for cities, as well as weather radar, report and hurricane coverage.” You may be using a London UK IP address, for example, so Google has completely missed the point; no hurricanes here and you are in London. This whether report would have been scrapped off of a web page after it had been written, and the time span may also vary considerably? So again it is old and not relevant to you because of distance.

Surely the system should know if you search for the word “weather” in any language, then you mean what the weather is like right now and here! Moreover what is the forecast? Again you are going to turn to the TV or radio or just have to wait, or use an inaccurate weather widget on your Smartphone. Type the same word into a system embodying the present invention, however, and your search results may be from weather report that is 4 minutes old from London!

3) For the last example, let us assume you are Iraqi citizen and a bomb goes off in the city you live in. Google and most search engines are not particularly good in other languages, hence the rise of dedicated search engines such as Yandex (Russia). If you did manage to search in English in Google for the word bomb and your city, there will be no way that you are going to get fast relevant results. Again Twitter, Facebook or the local TV would be your best bet, and again TV is not searchable.

To address these problems and challenges, certain embodiments of the invention access, monitor, and extract searchable information from a plurality of sources providing live, immediate, and trustworthy data, relevant to users right now in all of the situations above and in any language. Thus, embodiments of the invention have addressed the questions of: where is that data, who is using it, and how do we make it index-able and searchable?

From the above summary, and following detailed description, it will be appreciated that certain aspects provide:
A live search of all media broadcasted within 5 seconds! (The Spoken Word, globally).
A revolutionary search algorithm.
A new agnostic time sensitive search.
Language independent searching/search interface.
Time & location sensitive searching.
Personalised information relevant to the User, selected by the User.
Constantly updating, automatically searching and scanning for keywords & alerts the User.
A whole new way to interface with the Web.
A mobile device app that will alert the User.

As further background on the old web-based search engines, Google Bing and Yahoo all pre-rank sites with authority so that if a well-known site with lots of links to it reported any of the events described above and the article writers wrote the news quickly, you may be able to search for it within a few hours, maybe minutes, if they happened to have somebody writing about what is going on in your local area right now. However, what if Joe Bloggs who lives down the road had a small website or blog, and was reporting and writing about what was going on right now? Even if Joe Bloggs were to be sitting in front of the event, writing the only and relevant information about the situation, would he be relevant in the eyes of Google? The current Google algorithm would not rank him in any way—therefore the user will never find his data or article, because his site does not have authority and it would not matter what he said. That is why if you are Wal-Mart selling a widget or if you are a small company down the road selling widgets, Google will rank Wal-Mart's site above yours, because they have authority. So the Web as we know it has a predefined rank that may have has no relevance to the user, only relevance to Google Bing or Yahoo. Again the web is ranked and listed in order of relevance to the seach engines and not the user.

all other search engines really are wading through pre-graded online shops and encyclopaedias trying to work out what the user wants. They are relying on the input of words or phrases and then trying to work out what the user meant, using language.

The present inventors have identified that users may be better served by harnessing new data sources. These data sources may effectively be instant information sources, and may be utilised together with fast responding websites and Twitter information. In certain embodiments, the data from such sources is run through the following algorithm, which is a Distance Based Search Ranking Algorithm, using longitude and latitude of published data against longitude and latitude on the content of the data.

Each media source publishes news and data, each media source also has a head office and a target audience. Each one of these can be converted into Latitude and Longitude.

This will be known as (Publisher Latitude) Plat & (Publisher Longitude) PLong.

Each publisher could be talking about or publishing information regarding a town or city, in this example we could say City London England (the financial centre known as the square mile)

The City London England (Article Latitude) ALat & (Article Longitude) ALong, this gives the latitude and longitude of the subject of the data.

We also have the location of the person searching or reading this data—we will call this the (User Latitude) ULat & (User Longitude) ULong.

From the above data we extract 2 distances:

PDist: Publisher distance from news story

UDist: User distance from news story

In certain embodiments, the formula for calculating the importance to the user about an article from a singular publisher is:

I=(1/PDist)/UDist

When there is more than 1 publisher reporting on the same story, this becomes:

I=((1/PDist1)/UDist)+((1/PDist2)/UDist)+((1/PDist3)/UDist)+((1/PDist4)/UDist)

This becomes:

I=((1/PDist1)+(1/PDist2)+(1/PDist3)+(1/PDist4) . . . )/UDist

This is then put through a logging function to act as a damping factor:

I=Log (((1/PDist1)+(1/PDist2)+(1/PDist3)+(1/PDist4) . . . )/UDist)

Now we still haven't got the time component in, and an older story is of less value to the user than breaking news. Also it would be good to give the publisher who broke the story first kudos for doing so. We will add another variable:

PTime: Time in seconds since story was broke by publisher.

The formula for calculating the importance to the user about an article from a singular publisher now is:

I=((1/PDist)/UDist)/PTime

Our multi news source formula now becomes:

$$I = Log ( \frac{\begin{matrix}( ( 1 / PDist 1 ) / PTime 1 ) + ( ( 1 / PDist 2 ) / PTime 2 ) + \\ ( ( 1 / PDist 3 ) / PTime 3 ) + ( ( 1 / PDist 4 ) / PTime 4 ) …\end{matrix}}{UDist} )$$

Now this formula's output is a single numerical value which gives an importance factor against a search term. This enables the automation of deciding what is breaking news and what is important to the user based on their location without the user typing anything in. Also in certain circumstances a story of global or national importance would be getting reported on by so many sources, the user location would become less important as a factor, the above formula takes care of this example.

To order results, based on a search term entered by the user, all matches would be given a numerical importance value as following:

I₁=Log(((1/PDist1)/PTime1)/UDist)

I₂=Log(((1/PDist2)/PTime2)/UDist)

I₃=Log(((1/PDist3)/PTime3)/UDist)

The ordering of articles would be by importance in descending order.

None of this data can be obtained by using resource hungry web page scraping bots.

It will be appreciated that the above detailed equations are merely examples of how ranking/weighting of search results may be performed in certain embodiments. Other embodiments may employ different detailed equations, implementing one or more of the general principles regarding time/age and/or location ranking/weighting, as described elsewhere in this document.

The Live Data Sources

The present inventors realised that many TV news broadcasts, local TV news broadcasts and world news broadcasts have text and subtitles transmitted in the satellite data streams. This text is up-to-date live information that is broadcast and discarded. We have produced test hardware and software that sifts through the MPG satellite streams and collates all the subtitles, text and program information. These satellite broadcasts even transmit the local news, weather and local breaking news alerts. There are currently over 12,000 satellite broadcast streams worldwide in multiple languages! That is a huge amount of transmitted data around the world that is just broadcast and thrown away. Much of this data is live and represents an encapsulated snapshot of exactly what is going on in the world right now along with every documentary and informational broadcast.

To go back to point 1 (the floods in Penzance)—very quickly a local reporter will be on the scene in the local news. Talking about the floods as it happens and reporting live from the event. Currently this spoken language data is not captured used or ranked and does not appear anywhere on the internet. The capture of this data, the sorting of it and making this a fast searchable index, would mean that within seconds of the reporter saying “I am on the Penzance seafront and the waves are crashing in . . . ” a user could search for any of the words just spoken and the data that was just talked about only seconds before would be presented in the search result. The search result page is listed chronologically with all other live data on the same subject. There may have been other reporters also on the scene from many different news channels. Some a few hours before, some simultaneously with other reporters, so all channels are listed and displayed in comparison with the newest at the top. This page of results, unlike old search engines, refreshes every 60 seconds, so if something new happens while you are looking at your search results, then your results will automatically update and change. The search results also show a screen capture of the data feed along the captured words, and allows you to expand the data set, and or go to the live stream/the actual TV from the results (if it is a live result).

One aspect of the invention, successfully implemented by the inventors, is a system that successfully indexes ranks and lists all broadcasted words and phrases, language independent, in chronological order, multiplexing them with other data sets and streams. These new data streams have been interfaced with our agnostic table/Smartphone friendly “Touch Word” interface. Currently our time frame from reported broadcast event to a searchable term on our index is 10 seconds.

If you think back to example 2, “weather” (a very simple single word search term) with this system you type in the word weather and it displays the latest data set with the word “weather” it is always the latest report, it is always qualified data, it always ranks the data set that is closest to you and is always correct.

We also archive all data, so as you scroll down the page the articles and information ages. As everything is ranked in chronologically, if something was talked about days or months ago, it will be further down the page; this search results page scrolls down infinitely going backwards in time until there is no more data on the subject. As time progresses, one of the evolving aspects of the invention will be a searchable archive of every word or phrase spoken on broadcast media.

More Data

Some publishers only publish video data on YouTube, some very well-known news articles and channels also publish on YouTube. Certain embodiments provide a system that can, within a few minutes of the article's or video's release, take the YouTube video and convert it into a written article. Using our technology this can create a subtitle data set feed identical to the satellite system and insert it into our index, exactly as if it had also just been broadcasted on the TV. This system can convert the data into 75 languages, again this is even more data that has never been utilized or seen before.

There are also qualified publishers who produce good relevant fast information via RSS. RSS (real simple syndication) this is nothing new but it has always been underutilized and it is an important added extra that will give diversity to the data sets developed by certain embodiments. So, some of the smaller publishers that produce relevant information will be compared to and appear next to the bigger establishment articles.

Even More Live Data!

There is actually no need to crawl the Web at all—as said before, RSS has never really had the expected uptake, as it is mostly used in separate news aggregator programs. The only real web based RSS system is by feedly.com—we talk about them in case study number 2 below. RSS feeds are live updates of a website's activity, regardless of what type of website it is. RSS feeds are available from forums, e-commerce and news sites. Amazon has a feed for every category of every product they sell, with affiliate payments tied in. So without us having to sift through the whole of Amazon's website, we can just download the latest products and insert them into the same system as in exactly the same way as all the other data sets. Just about every website that is worth indexing has some sort of live feed. All of the big sites supply RSS feeds, Yahoo Answers, eBay, Amazon, most holiday sites and the comparison sites. We do not need the huge systems behind the scenes like the massive Google data centres. If a site is not professional enough or up to date enough to supply a good RSS feed, then we do not want it in our index—we want live up-to-date data about now, not some webpage that was written 5 years ago. So, in a nutshell, we can combine live satellite data from every TV channel that supplies subtitles and close captions, YouTube, and qualified clean website data. We can then make every data set including every broadcasted spoken word in the world searchable within 10 seconds of us getting the data.

Other Languages & Our Intuitive “Touch Word” Interface

Swahili or Russian Anybody?

Another aspect of the invention, which may be employed on its own, or combined with any other aspect of the invention, is a user interface (an agnostic interface) which we shall refer to as “Touch Word”. Further details of the Touch Word aspect, and certain of its embodiments, are set out later in this specification. Because we have built a system that does not care about the words, it actually does not matter what language it is in. Our agnostic search system uses a completely new “Touch Word” interface, alongside a traditional search bar. The interface removes all small words that are meaningless for the user like “if”, “the”, “a”, “i”, etc.—it then also combines and actively looks for capital words to join together. This has to be carried out to make a single search term for phrases such as names “David Cameron” would be picked up a single term and not separate words as would Bank of England. These rules will vary for other languages, but exactly the same rules apply—remove all meaningless words and join together phrases.

As I am using an English keyboard I cannot actually type in the Spanish word “Espan̆a”. This is because I do not have the letter “n̆” on my keyboard, therefore, I cannot search for that exact word—think about that in Japanese or Arabic.

We have yet to find a website that understands that neither Smartphone or Tablet users, do not want to touch a search bar and have to switch to a virtual keyboard to type in what they want.

Using our agnostic system, described in detail later in this specification, you can select words from a live broadcast filtered in any language, click or touch the word and search for it, just by touching the word—no need for a keyboard; no need to hit the return key or copy-paste in to a new search window etc. As our index does not care about language—it only filters by it; we can have articles transmitted in or written in Swahili or Russian or even Mandarin. The user can either type in a word or phrase using a standard search bar or click or touch it while viewing the live feeds. The agnostic search will only return articles in the language containing that word or phrase.

Unbiased Fair Search Results

Search engines/methods/systems embodying the invention do not take sides! All the information from all the channels is available to compare in a single result. It is very obvious, when using our system, different countries' news channels report on different events, often in a contradictory manner to the others. If you use our system to search for an on-going current event like “Ukraine”, it is apparent all too quickly that there is totally conflicting information out there. Interestingly enough, the only other news system that we are aware of that does this is the DrudgeReport and this is the world's biggest news website. This comparison search works equally well from products, hotels and shopping—as we will discuss later. A typical search result from either your pre-defined alerts or from a search, looks like the page below. These zones can be expanded when clicked on to view more information or play video/TV streams regarding the search terms. The first screen capture below is the current search term output for “Putin”.

Case Study 1

The Drudge Report (*3)

Drudge Report Statistics (*4) This news site is approximately n umber 400 in the world site rankings, around 10 billion page hits per year.

As we have started looking at drugereport.com, we may as well look at it as a case study. The drudgereport.com is the biggest news website in the western world yet they do not write a single article of their own. This site is a news aggregator, they use handpicked articles that they feel offer a fair view of the world and are of use to their readers. The site looks very dated, and is still subject to all the failures of the Google results, without even needing Google to refer them traffic. That is because these are web-based articles that still have to be written, uploaded to the web, reviewed by a Drudge report editor and then approved for release. May be some are automatically marked for immediate release from trusted sources but as far as our studies can tell, there is definitely hours of lag and sometimes, days. This is more like a daily newspaper. However we can definitely work out their readership and statistics in order to gain some idea of revenue streams and income. Although our system is not a news aggregator, it can as easily return results just for news as it can for standard websites/TV broadcasts'. YouTube videos and RSS feeds. It has the power to gain up-to-date news automatically, within seconds. Obviously our feeds do not need to go through an editor and are totally unbiased.

Case Study 2

Feedly (*5)

Feedly Statistics (*6) This RSS aggregator is approximately number 350 in the world site rankings—around 11 billion page hits per year.

This system requires a login and you then need to add RSS feeds to your personal pages. They do have a discovery system but although they have massive traffic, they have completely missed the point. You cannot search the feeds for data unless you have the feed already. Moreover, you can only search inside the feeds you have added to your personal area. Also, there is no historic data held, so if you created a new account today and added 100 feeds, all you would see is today's data. Your historical data will then build over time. There is absolutely no live feel about it. This system is a good idea but basically it is just an RSS reader program that has been turned into a website. We have tried many keywords that we see drop into our front pages. The Feedly search returns “no results” because we have to add the feed to our area then search manually. We also noticed a 5-25 minute delay from RSS publishing time to their system being able to display any form of search result from the personal area. It seems they have also not understood that people today want the data—now. There are some very temporally sensitive searches, such as share price drops. It's no good finding out 15 minutes after the fact. There is also no alert system, how are you going to know about any information updates without endlessly searching over and over!

If the user is actually looking at a green front page box, with the words “NOW” in the time stamp, it is fair to say they are interested in seeing/reading and watching the exact moment that is being talked about. The search result will open up with a live stream feed going to the TV channel related to that particular TV broadcast and will start to stream the channel live. The stream will stay open and lives for as long as the user remains on that page, and our revenue will be 33% of all advertising during the whole duration that the user is watching the channel. The live search list below will still update every sixty seconds, so they can still see if any new information arrives from another data stream.

Further embodiments of the invention will now be described in more detail, with reference to the accompanying figures.

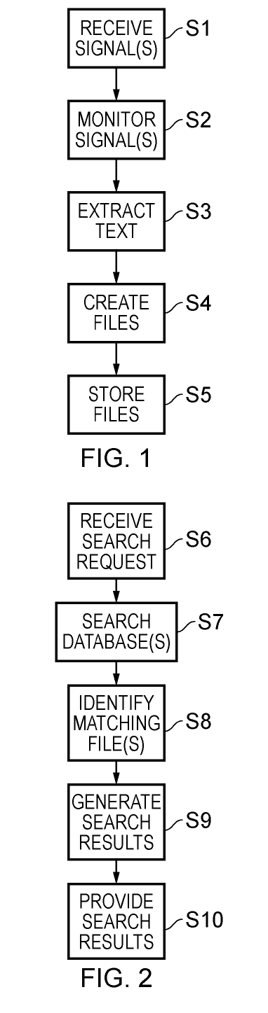

Referring now to FIG. 1, this illustrates steps in a method of generating a database in accordance with one aspect of the invention, and which may be used in automated methods of generating and/or providing search results in accordance with other aspects of the present invention. Step S1 comprises receiving at least one signal, the or each signal carrying at least one of text information and audio information. S2 comprises monitoring the received signal or signals. Step S3 comprises extracting, from each of the respective plurality of portions of the or each signal, at least a respective quantity of text corresponding to text and/or audio information carried by the respective portion of the signal. Step S4 comprises creating a plurality of files (which may also be described as database files), each file corresponding to a respective one of the plurality of portions and comprising the respective quantity of text. Then, in step S5 the method comprises storing the created files in at least one database. Thus, the database may be frequently and continually updated with files containing searchable text information extracted from the signal or signals being received and monitored. There is no requirement for human interaction, and thus the method can be employed to monitor a very large number of signals from a corresponding variety of sources in order to provide a body of searchable information that may be searched using new search methods (which may also be described as new search engines) in accordance with other aspects of the present invention, or indeed with conventional search methods or search engines.

Referring now to FIG. 2, this shows a search method in accordance with an aspect of the invention and which may be combined with the method of FIG. 1 to provide an overall automated method of providing search results to a user device. The method of FIG. 2 includes step S6 which comprises receiving a search request (which may also be described as a search message or signal including a search request) from a user device (or indeed from other apparatus), the search request including at least one search term (e.g. word or character string) or information indicative of that at least one search term. Then, in step S7 the method comprises searching at least one database (for example the at least one database referred to above with regard to FIG. 1) for matching files, the or each matching file being one of the files stored in the at least one database and which contains text corresponding to the at least one search term. Step S8 comprises identifying one or more matching files. It will be appreciated that steps S7 and S8 may be combined in certain embodiments. In step S9 the method further comprises generating search results based on the at least one matching file identified steps S7 and S8. Finally, the method comprises step S10, in which the generated search results are provided to the user device that originated the search request (or to other such apparatus originating the search request), for example by transmitting those search results to, or for reception by, the user device or other apparatus.

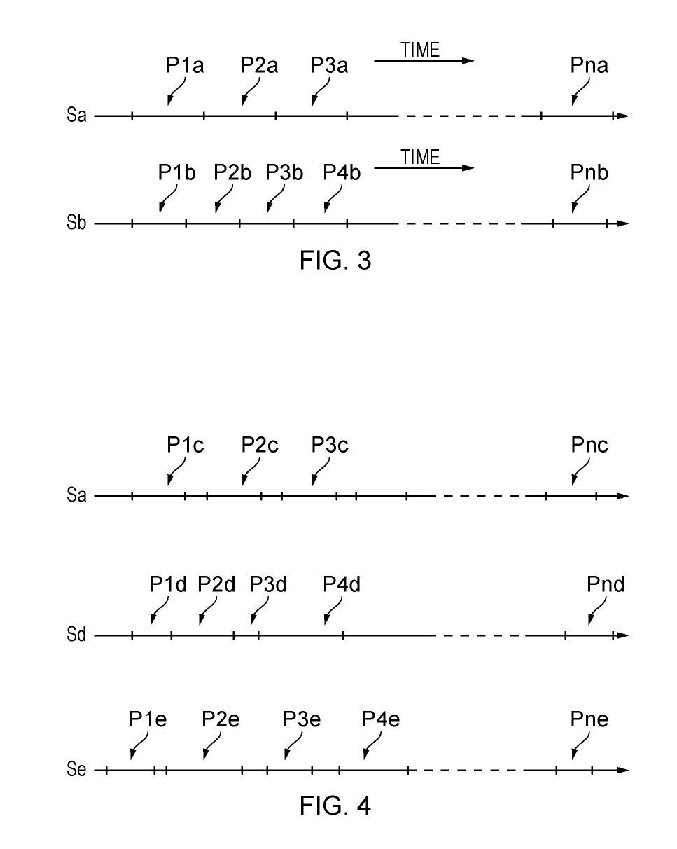

Referring now to FIG. 3, this shows two signals, SA and SB which may be received and/or monitored in embodiments of the invention. The respective plurality of portions from which corresponding quantities of text are extracted in methods embodying the invention are shown on the figure. Thus, for signal SA, the respective plurality of portions P1A, P2A PNA are immediately consecutive portions of the signal, each corresponding to a respective time interval, those time intervals all having the same length as each other. Thus, the contents of every portion of the signal can be reflected in the searchable database files created. For the second signal SB, the plurality of respective portions again are immediately consecutive portions, and all have the same length as each other, although this length is different from the length of the portions of the first signal SA. Thus, in embodiments of the invention the portions of signals being monitored may not necessarily all have the same lengths as each other.

Referring now to FIG. 4, this illustrates a plurality of signals which may be monitored using methods of apparatus in accordance with other aspects of the invention. Of these three signals, the first signal SC is monitored and processed such that respective text information is extracted from a plurality of portions of the signal P1C-PNC which have the same length as each other but are not immediately consecutive, in the sense that there are small time gaps in between them. Thus, in certain embodiments the invention text information is not necessarily extracted from the entirety of a received signal; there may, in certain examples, be certain portions of the signal whose contents are not reflected in the created files. Clearly, however, it is preferable for any such portions not reflected in the searchable database to be as short as possible. The second signal monitored SD is processed such that respective text information is extracted from a plurality of portions P1D-PND, which are immediately consecutive portions, but vary in length. Thus, although in certain embodiments each created file corresponds to text information corresponding to equal time periods or chunks of a monitored signal, this is not necessarily the case in all embodiments. Finally, the third signal being monitored SE is processed such that respective text information is extracted from a plurality of portions P1E-PNE which are not immediately consecutive and which do not all have the same length. Thus, the separation between the portions may additionally not be constant. Again, however, it is desirable, generally, for time portions of any signal not reflected in the created files to be as short as possible.

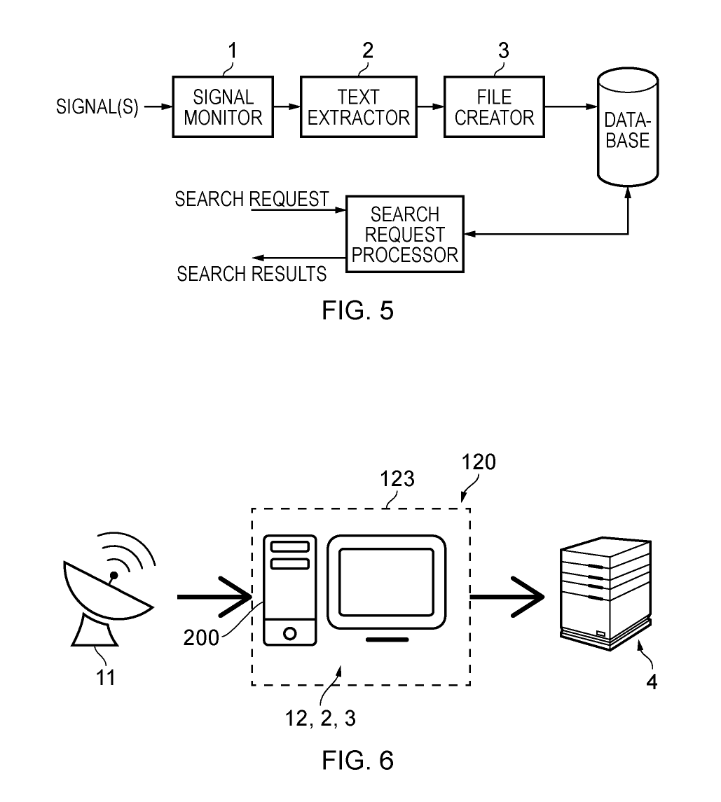

Referring now to FIG. 5, this illustrates apparatus, which may also be described as a system, in accordance with an embodiment of another aspect of the invention. The apparatus of FIG. 5 is arranged to generate search results automatically in response to receiving a search request (i.e. a signal or message containing information on which a search is to be based). The apparatus comprises:
signal receiving and/or monitoring means 1 (e.g. at least one signal monitor, unit, or module, or signal monitoring server) arranged to receive and/or monitor at least one signal carrying at least one of text information and audio information;
extraction means 2 (e.g. text extraction means, or at least one text extractor, unit, or module, or text extracting server) arranged in communication with the signal receiving and/or monitoring means and further arranged to extract, from each of a plurality of portions of the or each signal, at least a respective quantity of text corresponding to text and/or audio information carried by the respective portion of the signal;
file creating means 3 (or at least one file creator, unit, or module, or file creating server) arranged in communication with the extraction means and further arranged to create a plurality of files, each file corresponding to a respective one of said plurality of portions and comprising said respective quantity of text;
file storage means 4 (e.g. at least one file store, memory, database, unit or module, or file storage server) arranged in communication with the file creating means and arranged to store said files; and
search request processing means 5 (e.g. at least one search request processor, unit, or module, or search request processing server) arranged to: receive a search request (e.g. from a user device), said search request including at least one search term or information indicative of said at least one search term; search said file storage means for at least one matching file, the or each matching file being one of said files containing text corresponding to said at least one search term; and generate search results based on said at least one matching file. The search request processing means 5 may be further arranged to transmit the generated search results to (i.e. for reception by) a device or apparatus from which the search request originated.

Referring now to FIG. 6, this illustrates a collection of apparatus, in other words a system, in accordance with one aspect of the invention and which is able to automatically generate, update, and/or maintain a searchable database. The system may also be referred to as apparatus comprising a “node” 120 arranged to gather live satellite data, convert it, and upload it to a database, that database embodying another aspect of the invention. The database is arranged (or, equivalently, configured) for use by other apparatus and methods embodying certain aspects of the invention. The system comprises a satellite receiver 11 (a signal receiver), which may also be described as a dish, arranged to receive at least one signal transmitted by (i.e. from) at least one satellite. The system further comprises signal monitoring means 12, extraction means 2, and file creation means 3 in the form of a computer 200 fitted with a satellite capture card. Thus, the computer provides the signal monitoring means, extraction means, and file creation means as described above with reference to FIG. 5. This computer with satellite capture card may be described as a satellite node 123, monitoring at least one signal received via the dish 11, and is arranged to record 10 second chunks of the program it is tuned to (i.e. one of the signals or programs carried by the received satellite signal). Each chunk or portion in this example is stored in the computer as a temporary file. Although in this example the time period of 10 seconds is employed, this period or chunk of time can be arbitrary, and other time periods may be used. However, for certain embodiments of the invention particularly concerned with the extraction of information from satellite signals it has been found that signal portions or chunks of duration 10-15 seconds work well. These portions of the received/monitored satellite signal (e.g. 10 second chunks) each have a different file (temporary file) and are stamped numerically in a folder. This process is performed by software installed in and running on the computer. A watcher program also installed in and running on the computer watches the folder the files are being saved in, and when a new file is saved, the watcher program performs the following:

1. It executes an extraction program which extracts any sub-title information stored in the file.

2. It executes a program which extracts a still image from the file (if available).

3. It runs a clean-up routine which removes duplicate text from the file (e.g. from the roll up closed caption format).

4. It collates the information, including the image, into a file, for example an XML file. In other words, it creates a database file.

5. It deletes the processed file (in other words the files initially created, storing program or signal chunks, are temporary files, and after the relevant text and/or image information has been extracted, the temporary files are deleted).

6. It sends the date stamped file (i.e. the created database file, e.g. the XML file) to a server 4, for example via an HTTP post, for immediate insertion into a live database (e.g. a live database stored on the server 4), the file containing, in this embodiment: program ID information (which may also be referred to as stream ID information); a date stamp (i.e. time information indicative of time of creation of the file, and hence broadly indicative of time of reception of the respective signal or signal portion); sub-title data (i.e. text information extracted from the respective portion of the respective signal); and image data (i.e. image information, if available, from the respective signal portion). In order to reduce strain on the computer's hard drive, a ram disk may be used to store and process the files (e.g. the temporary files and the created database files, before the latter are sent to the database). In certain embodiments, after each database file has been transmitted to the database, no copy of it is retained by the node.

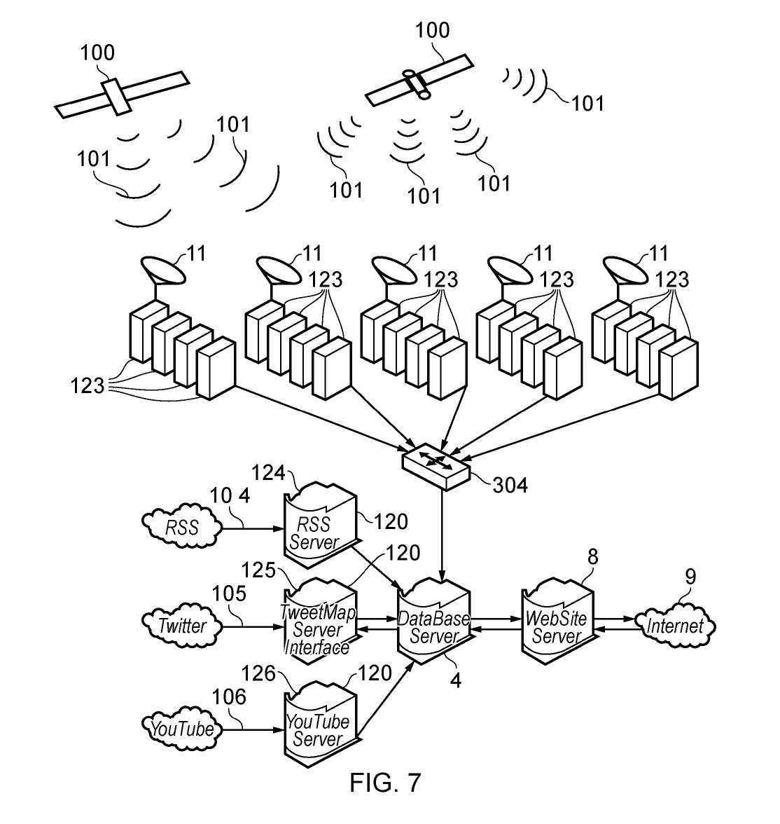

Referring now to FIG. 7, this shows another system embodying one aspect of the invention. The system comprises a plurality of satellite signal receivers, or dishes, 11 arranged at a plurality of respective locations to receive satellite signals 101 from a plurality of satellites 100. Each dish 11 feeds a respective plurality of received signals (i.e. signals that were carried by the received satellite signals 101) to a respective plurality of satellite nodes 123. In this example there are four nodes at each site (i.e. for each dish), but different numbers of nodes may be employed in alternative embodiments. Each satellite node is tuned to at least one respective signal (e.g. channel, programme, or feed) and performs monitoring, extraction, and file creation processing in accordance with the description above, so as to create database files which the node then sends, via a router 304 in this example, to at least one database server 4 for storage (and subsequent access by search processing means, search engines etc.). In addition to creating database files from satellite signals, this embodiment further comprises a plurality of nodes arranged to monitor, and create database files from, a respective plurality of terrestrial signals, in this example signals received in the form of feeds via the internet. Thus, the system includes a node 124 in the form of an RSS server, arranged to receive at least one RSS feed signal 104, and monitor, extract, and create corresponding database files generally as described above. Those database files derived from an RSS feed are also sent to the server 4 for inclusion in the searchable database. Similarly, the system comprises a TweetMap Server Interface 125 arranged to receive, monitor, and create database files from a Twitter feed signal 105, and a YouTube server 126 arranged to receive, monitor, and create database files from a YouTube feed signal 106. It will be appreciated that other terrestrial signals may additionally, or alternatively, be monitored and processed in alternative embodiments. In this example a website server 8 is arranged to perform searching of the at least one database 4 in response to received search request messages. That searching includes searching in accordance with prior art search techniques, and searching in accordance with search methods embodying other aspects of the present invention. Thus, the search server 8 may be arranged to implement a search engine embodying an aspect of the invention. In this example, the search server 8 is arranged to interact (interface) with remote apparatus, users, user devices etc. (i.e. originators of search requests) via the internet 9, but alternative embodiments may employ additional, or alternative, interface (i.e. information exchange) means. The website server 8 thus receives and processes search requests, performs searching, generates and ranks search results, and provides (sends) those search results to the search originator (originating device), via the internet and/or other means.

Referring to FIG. 7 again, in another embodiment, each satellite stream needs a single feed from a dish. For the illustrated set up, we have 4 satellite feeds from each dish. Each feed can contain more than a single data stream. An example of this would be that all of the BBC and BBC local stations are carried by one multiplexed signal. This multiplexed signal is decoded into many virtual feeds from a single physical feed. Each feed then goes into a small server, which contains a satellite decoder card. The server then breaks the MPG data stream down into its component parts—data, subtitles, program data and video. It then qualifies and rationalises the data into a single time stamped data stream to our database server with a screen capture once every 10 seconds of the channel. The database server is then connected to a much more powerful web server. The database server has levels of databases sorted by dataset age—these swap around, depending on the time stamps. As an article or dataset gets older it is moved into bigger slower areas, while the latest information is kept smaller. The speed one can rotate and update this database depends on the hardware. One can decentralize these tasks, using something like the MAIDSAFE network. One embodiment currently uses a single MySQL database server, but one can easily change to MySQL Cluster (*9) to scale up the system.

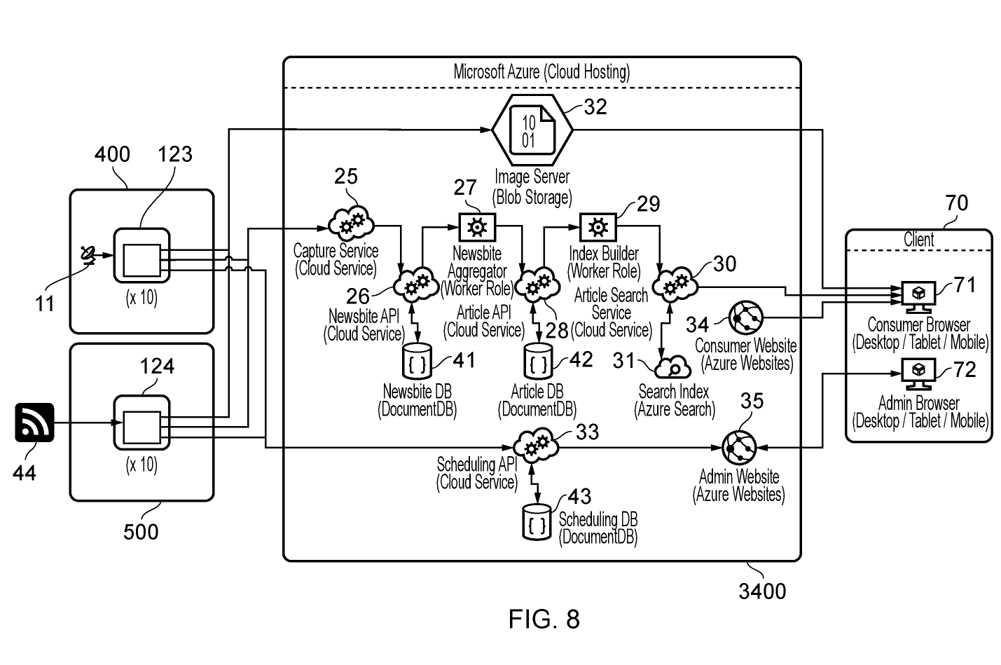

Referring now to FIG. 8, this illustrates another automated search system embodying an aspect of the invention. It utilises both RSS and satellite signal feeds to create and maintain searchable databases, and provides search results to a user device based on the contents of those databases. An overview of the RSS and satellite streams is as follows.

In certain embodiments, each satellite stream server needs a single feed, and in one example there are 4 satellite feeds from each dish. These 4 feeds are then fed into an 18 way multi-switch. Each multi-switch can then supply 18 separate physical feeds that supply 18 servers. Each feed can contain more than a single data stream. An example of this would be that all of the BBC and BBC local stations are carried by one multiplexed signal. This multiplexed signal is decoded into many virtual feeds from a single physical feed. Each feed then goes into a small server, which contains a satellite decoder card. The server then breaks the MPG data stream down into its component parts, data, subtitles, program data and video. It then qualifies and rationalises the data into a single time stamped data stream to a database server with a screen capture once every 10 seconds of the channel. The database server is then connected to a much more powerful web server. FIG. 8 shows one implementation, showing the plurality of different data streams and how this example of the system works. In one embodiment there are 32 servers set up, looking at different feeds from all over the world. Other embodiments may employ even greater numbers of servers, for example 250 servers per territory.

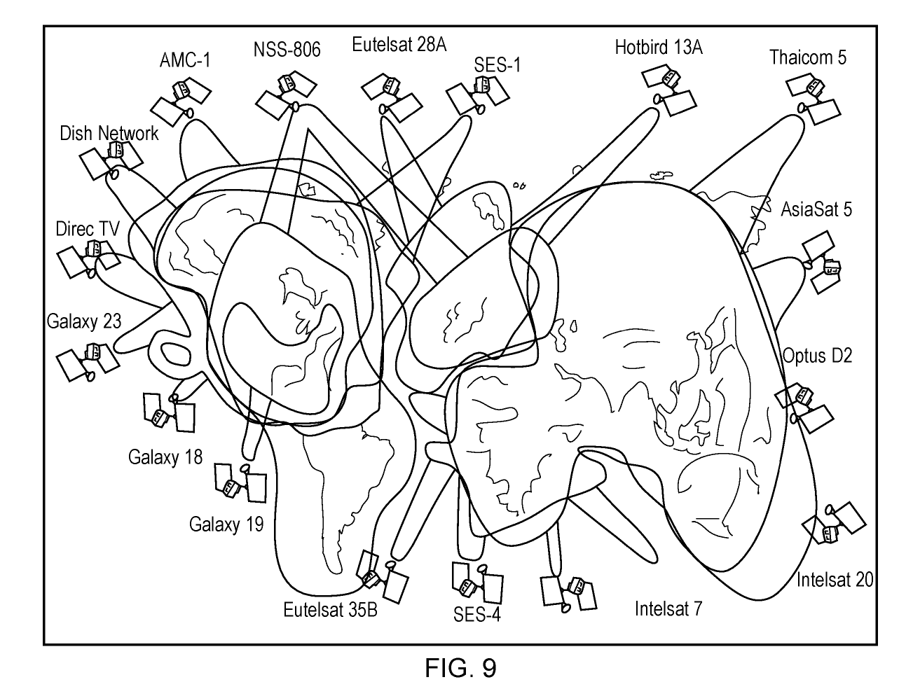

FIG. 9 illustrates satellite footprints and territory locations relevant to certain aspects of the invention. The names on each of the satellites in FIG. 9, and referred to below, do not necessarily represent a single satellite, but FIG. 9 is intended to show the footprints of the satellite fleets and their coverage alongside their names. For example SES is the company that runs the Astra satellite fleet that, at the time of writing, has a spot footprint on the UK that runs the Sky (BskyB) U.K. satellite broadcasts.

By breaking down all the satellite beam footprints, one can deduce that certain embodiments need 4 separate locations (i.e. satellite signal receiving locations) around the World, to cover all broadcast territories. Generally, these four locations are:

1) North American Territory

For example Kansas, Colorado, Oklahoma, or Nebraska. Any of these central states provide a good location for signal strength. As can be seen from FIG. 9, this even covers South America.

2) UK/European Territory

For example southern France, northern Italy, Switzerland or southern Germany provide good locations for signal strength.

3) African/Eastern European/Asia Territory

For example anywhere in South Africa to cover all of the above areas. 4) Australian Territory

For example anywhere in Australia.

There is obviously some overlap of signal coverage. To capture the maximum amount of data all four of the above locations are required. Thus, certain embodiments employ receivers in all four of these locations/areas, but certain alternative embodiments do not.

Referring again to FIG. 8, an overview of the use of RSS in this embodiment is as follows. There are qualified publishing sources on the net (internet) that can be picked up by using an RSS feed. This data is normally good relevant fast information. RSS (real simple syndication) feeds are thus used in certain embodiments. An RSS feed in itself is not new but it has, in the past, generally been underutilized, and it is an important alternative and/or additional source of information usable by embodiments of the invention, for example to give increased diversity to the searchable data sets. Some of the smaller publishers that produce relevant information will be compared to and appear next to the bigger establishment articles. This type of data is interleaved into an index in certain embodiments and can be filtered to be viewed with the live TV streams, for example, or separately.

An overview of indexing used in certain embodiments is as follows. The indexing system may index the subtitle data that is captured along with a screen shot. The index is temporally based, so that everything is listed with the latest data at the top of the page. The key to this system is that it will work on any broadcast channel that has any subtitle or closed caption data and it uses that as a data set to build a searchable database in the language that has been captured.

Referring still to FIG. 8, in this embodiment a data centre 400 comprises at least one satellite signal receiver (dish) 11 arranged to feed received signals to a plurality of satellite nodes 123 (in this example there are ten satellite nodes). Each satellite node is arranged to monitor at least one respective satellite feed signal, capturing time chunks generally as described above, and generating a plurality of time-stamped database files for sending to the cloud-hosted processing and data storage employed by this aspect. Thus, each satellite node captures at least one respective satellite feed and extracts text and image data, if available. Thus, the data centre (TV Node Safelight Receivers) in this example comprises servers that are capturing and decoding the satellite streams, turning the received signals into an outbound stream of text and pictures. These servers decode, clean and upload the processed information (newsbites) to the capture service 25 and send the images to the image server 32.

The system also comprises a module 500 (in this example a Digital Ocean (3^{rd} Party VM) module) which comprises rssnodes or rss collection servers. The module 500 includes a plurality (ten again, in this example) of RSS nodes 124, each arranged to receive at least one respective signal from an RSS feed 44 and generate corresponding pluralities of database files, generally as described above. Thus, each RSS node 124 is arranged to capture at least one respective RSS feed signal, and extract text and image data, as available. In more detail, the RSS (Digital Ocean) nodes are remote virtual machines provided by Digital Ocean. These have the dual purpose of both fetching the RSS feed data and fetching and processing the web pages. These are geo-located in the cloud giving us a global presence by IP. Therefore, in certain embodiments, we may have 10 based in the USA, 10 based in Germany, 10 based in the UK etc. The nodes are allocated pages to scrape, by the management system, which picks up the RSS feed, also sent from the same nodes. In certain embodiments the RSS feeds are used for page discovery only, in which case the system need not actually use the data within the feeds themselves. The nodes may be arranged to then process the allotted web page and convert it into stream of text and pictures. The nodes may then decode, clean and upload the processed information to the capture service and send the images to the image server.

In this embodiment, a plurality of databases, processing operations, servers, and websites utilised by the system are cloud-hosted (e.g. using Microsoft Azure). The cloud-hosted system (e.g. by Azure Cloud) is indicated by reference 3400. The system components (entities, modules, etc) include an image server (blob storage) 32, a capture service (cloud service) 25, a Newsbite API (cloud service) 26 [API stands for ?], a Newsbite database (DB) (document DB) 41, a Newsbite aggregator (worker role) 27, Article API (cloud service) 28, Article database (DB) (document DB) 42, Index Builder (worker role) 29, Article Search Service (cloud service) 30, Search Index (Azure Search) 31, Scheduling API (cloud service) 33, Scheduling database (DB) (document DB) 43, Consumer website (Azure websites) 34, and Admin Website (Azure websites) 35. The system is adapted to interface with (i.e. receive search requests and/or other messages from, and send search results and/or other information to) a user (or client) device 70, on which is installed or provided a consumer browser (desktop/tablet/mobile) 71 and an Admin browser (desktop/tablet/mobile) 72. The interactions and communication paths between the respective entities in the system of FIG. 8 are indicated by the connecting lines and arrows. Referring still to the Azure Cloud 3400, the newsbites from the nodes 123 and 124 are then passed on by the capture service 25 and then saved on the newsbite database 41. The Images are saved in blob storage 32 as raw data, using base 64, not as pictures. The scheduling system 33, 43 comprises a database of all the TV channels, and controls the times at which the system accepts data from the data centre TV nodes. The TV nodes transmit the data all of the time; it is the management system that dictates if the data is entered into the database. The search index 31 is a live index, likely to be using “elastic search” that allows the article database 42 (which is the consolidated data from all sources) to be searched, and relevant data (i.e. search results) to be returned. The consumer website 34 is made up of multiple geo-located proxies that all use an API to interview the article database 42 and index 31. The cloud expands and contracts depending on processor storage and traffic requirements. The Admin website 35 provides an interface for inputs to a management console/system/module that controls the scheduling, feed sources and monitoring of all servers.

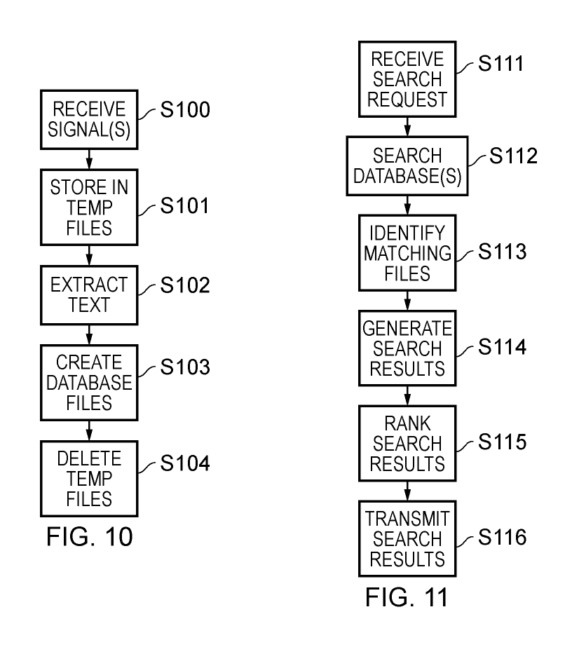

Referring now to FIG. 10, this illustrates steps in another method embodying an aspect of the invention. The method includes receiving a signal carrying text and/or audio information (step S100), storing portions of the signal in a plurality of temporary files (step S101), extracting from each portion a respective quantity of text information corresponding to text and/or audio information carried by that portion) (step S102), creating a corresponding plurality of database files (i.e. for sending to, and storage in, a database) (step S103), and deleting the temporary files (step S104). In this example, the deleting of a temporary file is performed after creation of the respective database file, although in certain other embodiments this deletion may be performed before the creation of the database file has been completed, e.g. after the extraction process. In certain embodiments the temporary files may be deleted on a one-by-one basis, for example as the creation of each respective database file is completed, or may be deleted in batches.

Referring now to FIG. 11, this illustrates steps in another method embodying an aspect of the invention. The method is an automated (e.g. computer implemented) method of generating search results. The method includes: receiving a search request (e.g. a search request message or signal) including at least one search term or information indicative of said at least one search term (step S111): searching at least one database for matching files, said at least one database comprising a plurality of files each comprising at least a respective quantity of text and respective time information indicative of a time of, associated with, or corresponding to creation of the respective file, or, equivalently, indicative of an age or “newness” of the contained information (step S111); identifying a plurality of matching files, the or each matching file being one of said files containing text corresponding to said at least one search term (step S113); generating a respective search result (i.e. information) for each matching file (i.e. based on information stored in the matching file) (step S114); ranking the search results according to at least one criterion (step S115); and transmitting the search results to (i.e. for reception by) an originator of the search request (S116). The ranked search results may be transmitted in any suitable format, such as individually, each with a respective ranking, or collectively, in one or more groups.

The ranking of the search results in certain embodiments comprises ranking the respective search results according to at least one of: said time information; source location information indicative of a location (i.e. a source location) of, corresponding to, or associated with, a source (e.g. originator, creator, author, publisher, broadcaster, reporter) of the respective file, a signal from which the file was derived, and/or its contents; user device location information indicative of a location of, corresponding to, or associated with, a user device originating said search request; and subject location information indicative of a location of, corresponding to, or associated with, a subject of said respective quantity of text.

Thus, in ranking the search results, respective weightings may be applied according to at least one of: the “age” of the respective information/file on the database; a location of the originator of the search request; a distance between a source of the respective file and a location of a subject of, or referred to in, the file; a distance between the location of the search request originator and a location of a subject of the file, etc.

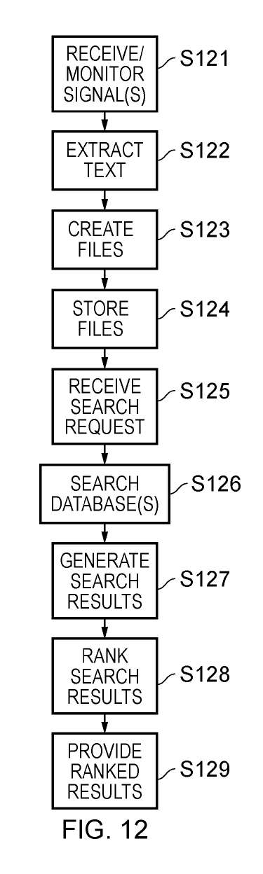

Referring now to FIG. 12, this illustrates steps in another method embodying an aspect of the invention. The method is an automated (e.g. computer implemented) method of generating search results. The method comprises: receiving and/or monitoring at least one signal, the or each signal carrying at least one of text information and audio information (step S121); extracting, from each of a respective plurality of portions of the or each signal, at least a respective quantity of text corresponding to text and/or audio information carried by the respective portion of the signal (step S122); creating a plurality of files (which may also be described as database files), each file corresponding to a respective one of said plurality of portions and comprising said respective quantity of text (step S123); storing said files in at least one database (S124); receiving a search request (e.g. a search request message or signal, optionally from a user device) including at least one search term or information indicative of said at least one search term (S125): searching said at least one database to identify a plurality of matching files, each matching file being one of said files containing text corresponding to said at least one search term (S126); generating a respective search result corresponding to each matching file (S127); ranking the respective search results (S128); and providing the ranked search results (S129).

In certain embodiments, the ranking process/procedure comprises ranking the respective search results according to at least one of: time information indicative of a time associated with the respective file; source location information indicative of a location (i.e. a source location) of, corresponding to, or associated with, a source (e.g. originator, creator, author, publisher, broadcaster, reporter) of the respective signal or respective portion and/or its contents (e.g. said text and/or audio information); user device location information indicative of a location of, corresponding to, or associated with, a user device originating said search request; and subject location information indicative of a location of, corresponding to, or associated with, a subject of said respective quantity of text.

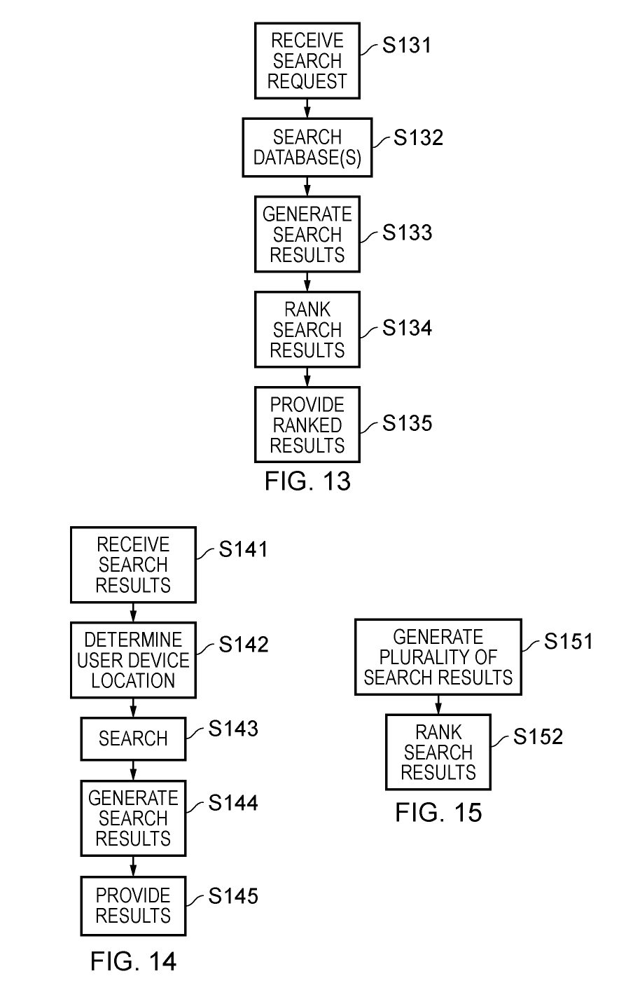

Referring now to FIG. 13, this illustrates steps in another method embodying an aspect of the invention. The method provides an automated (e.g. computer implemented) method of generating search results. The method comprises: receiving a search request (e.g. a search request message or signal) including at least one search term or information indicative of said at least one search term (step S131); searching at least one database to identify a plurality of matching files, said at least one database comprising a plurality of files each comprising at least a respective quantity of text and respective time information indicative of a time of, associated with, or corresponding to creation of the respective file, each matching file being one of said files containing text corresponding to said at least one search term (S132); generating a plurality of search results (i.e. information), each based on a respective one of said matching files (S133); and ranking the respective search results (step S134) according to at least one of: said time information; source location information indicative of a location (i.e. a source location) of, corresponding to, or associated with, a source (e.g. originator, creator, author, publisher, broadcaster, reporter) of the respective file, a signal from which the file was derived, and/or its contents; user device location information indicative of a location of, corresponding to, or associated with, a user device originating said search request; and subject location information indicative of a location of, corresponding to, or associated with, a subject of said respective quantity of text. The method also includes providing the ranked search results (e.g. to an originator of the search request) (S135).

Referring now to FIG. 14, this illustrates steps in another method embodying an aspect of the invention. The method is an automated method of providing search results to a user device, and includes: receiving a search request from a user device, the search request comprising information indicative of at least one search term (S141); determining a location of the user device (S142); searching at least one information source for search results based at least in part on the at least one search term and the location of the user device (S143); generating search results based on said searching (S144); and providing said search results to the user device (S145). The method may, optionally, include the further steps shown in FIG. 15, namely the generation of a plurality of search results (S151), and the ranking of the plurality of search results based at least in part on the location of the user device (S152).

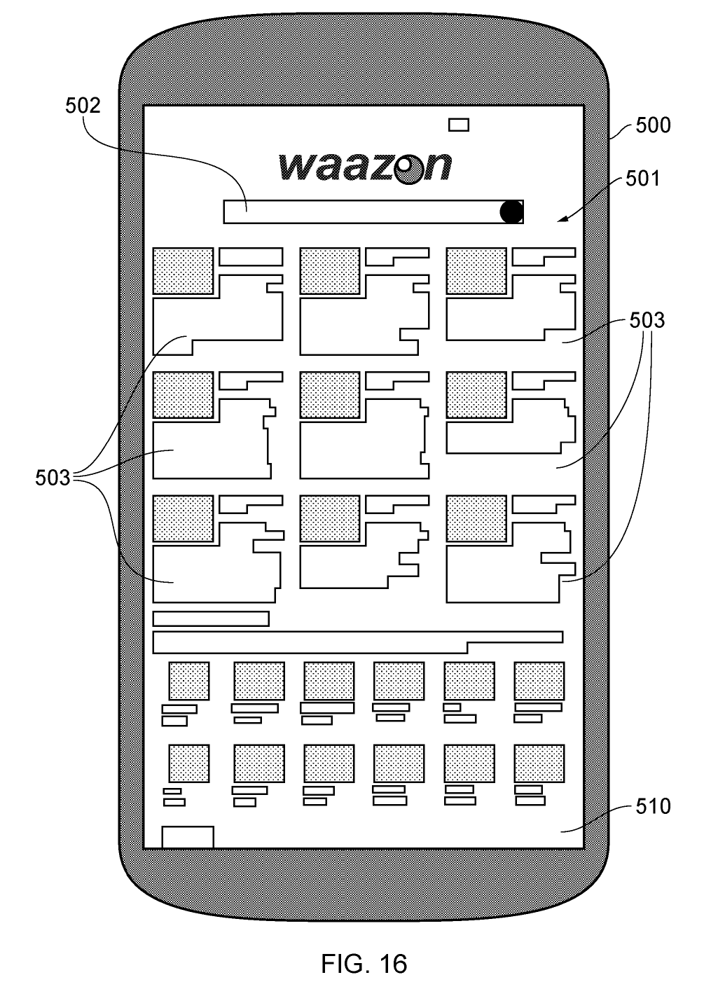

Referring now to FIG. 16, this illustrates user equipment running an application (App) (i.e. running, or executing, software) in accordance with another aspect of the invention. The App provides a user interface through which the user can interact with search methods, search systems, search engines, and databases in accordance with other aspects of the invention. Thus, via the App, the user is able to submit search requests, receive corresponding search results, and display those results ranked according to one or more of the criteria described in this specification. Thus, the App may be arranged to rank search results according to “newness” of the relevant information and/or according to user location, source location, subject location, etc. In certain embodiments, this ranking may be performed remotely, for example by a server processing the search request, and the App arranges the search results according to the received ranking, but in other embodiments a plurality of unranked search results may be provided to the user device by the search engine/system. In such embodiments, the App (i.e. the user device itself) may perform some processing to rank the results before displaying them. In yet further embodiments, the search engine/apparatus/system/method may perform initial ranking, and the user device (implementing/running the App, for example) may be arranged to perform further ranking. Thus, some time or age-based ranking may be performed remotely, and then some user-device-location-based ranking may be performed by the device itself. However, in certain other embodiments, all ranking is performed remotely from the device, such that the device merely has to display the ranked results it receives. In certain embodiments, the App is arranged to obtain location information indicative of a location of the user device, and transmit that information (for use by search methods, search engines, and search apparatus or systems embodying the invention) when it sends a search request. Thus, the App may be arranged to automatically provide user location information when a search request is initiated, enabling search results of increased relevance to be provided without the user explicitly having to include location information in their search terms (e.g. keywords). Alternatively, or additionally, the App may be arranged to obtain and send user location information in response to a request message from the search engine/system/apparatus. Thus, certain aspects of the invention provide apps for a variety of mobile user devices. These apps are able to place more emphasis on the location (and relevance) of the data, depending on the physical location of the mobile device. Important local information may thus be “grabbed” from broadcasts and sent as an alert, for example traffic information in a user's locality, weather information, accident information, sports results information, etc.

The Touch Word aspect of the invention, briefly referred to above, will now be described in more detail.

Touch Word Background

Internet search engines and hyperlinks play an important role when navigating the World Wide Web (WWW) as they provide a user friendly approach to finding relevant information and navigating between or within webpages or other Internet resources. For example, if a user wishes to obtain information on a specific topic they may enter a word related to the topic into an Internet search engine which will then present them with results that correspond to the search term. Hyperlinks may play a similar role where a particular word or image on a webpage may be associated with a link which takes the user to a webpage or a different portion of the current webpage that may provide further information on the word or image.

However, both of these approaches require either user selection of search terms and manual insertion into a search engine or require pre-programming. For example, if a user is reading a webpage relating to the Solar System and they wish to find further information on the planet Saturn, they may highlight the word Saturn and then copy and paste it into a search engine. Alternatively, the word Saturn may be a hyperlink to webpage relating to Saturn. However, this hyperlink is required to be manually determined and coded into the webpage code prior to the webpage being made available. Consequently, the act of navigating between webpages and the performance of searches, or the provision of functionality for the navigation between webpages can become time consuming. Furthermore, in the case of certain media types that may be presented via webpages, multimedia presentation mechanisms, television sets, video streaming or various other platforms, it may not be possible to insert hyperlinks or allow a user to copy and paste text for searching.

Thus, in light of these problems, the Touch Word aspects/embodiments of the invention enable displayable text of marked-up text to be identified and subsequently indicated, and words within the displayable text divided into textual elements. These textual elements may then be extracted from the displayable text and made the subject of a search via user selection. Textual elements therefore become directly searchable, thus enabling a user to easily and efficiently perform searches based on displayed text, whether it be text forming part of a webpage, subtitles, video commentary or comments and so forth, without the use of hyperlinks or copying and pasting of displayed text.

Detailed Description of Touch Word aspects and embodiments

In accordance with certain embodiments of the Touch Word aspects of the present invention, a text based processing technique is provided which enables text included in a variety of media sources to be extracted and to act as the input to Internet search engines or hyperlinks to Internet search results thus enabling text of various media sources to become directly searchable for example. This enables a user to quickly and easily extract text from media and thus search for terms included in text on webpages, video streams, social networks and the like. For example, in accordance with the present invention a webpage displayed to a user is processed in such a manner that words or sequences of words such as verbs, nouns, proper nouns adjectives etc. become directly searchable by simply selecting the words via the available user interface, such that upon selection of a word or term, the word or term is directly entered into an Internet search engine or a searching engine associated with the website provider and a search performed. A missing link between conventional Internet searching and hyperlinks is therefore provided which increases the ease with which a user may navigate the World Wide Web.

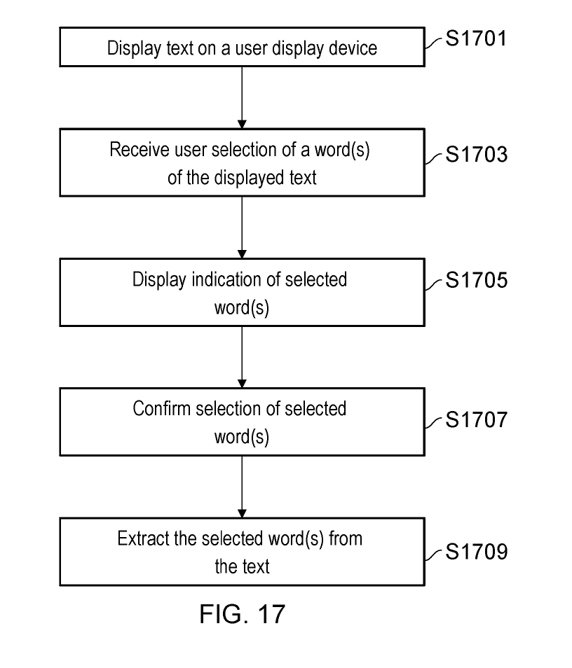

FIG. 17 provides a flow diagram which illustrates the functionality of embodiments of the present invention. At Step S1701, text which has been processed in accordance one or more of the methods explained below is displayed to a user on a user display device, which may be a mobile telephone, tablet computer, a conventional computer or a television set for example. The text may be in any form but preferably is communicated to the user display device in the form of marked-up text such as that included in HTML webpages.

Once displayed, at Step S1703 a user selects a word or a sequence of words which form a term or phrase, which may also be referred to as a textual element. For example, the user may select the term “Solar System” or “Saturn”. The user may perform the selection using any available user interface such as a touch screen interface, a mouse, a gesture based interface or a virtual reality interface for example. In the case of using a mouse, the selection may be performed by clicking on any of the words which form a textual element or simply by hovering or rolling-over the mouse cursor over a textual element.

At step S1705, upon selection of a textual element by a user, the selected textual element may be indicated to the user via a visual indication. For example, upon selection of a textual element the word(s) forming the selected textual element may change colour, change font, be presented in bold, change size or vary in any other suitable manner such as the type of shape of cursor may change in response to selecting a textual element.

At Step S1707, the user may confirm the selection of the selected textual element by performing a different user input to the one made in Step 1703 or alternatively by maintaining the user input which was input in Step 1703. For example the selection of step S1703 may be performed by a mouse cursor being placed over a textual element whereas the confirmation of the selection may be performed via a mouse click. Upon the conformation of the selection of the textual element the associated words may be at least temporarily presented in different style, colour or size for instance.

At Step S1709, once the selection of the textual element has been confirmed, the word(s) corresponding to the textual element are extracted from the displayed text such that they may be input into any process, program or function which allows text to be input. For example, the words of the selected textual element may be extracted and automatically input into an Internet search engine or a search engine associated with a particular website i.e. a local search engine. In one example, the extracted worlds may be directly input into a search engine and the user automatically presented with the results of the search such that a textual element acts as pseudo hyperlink to a search results page.

Although in FIG. 17 two selection steps, S1705 and S1707 have been described, one section step may also be used and the indication of the selection may be presented at different times. For example, in embodiments where a mouse is being used as the input device, as the mouse cursor travels over the displayed text, the words of each textual element over which the cursor travels are indicated whilst the cursor is over the words of the textual element. Subsequently, to select a textual element, the user clicks on an indicated textual element and the words forming the selected textual element are briefly displayed in an alternative colour or style for example. Alternatively, the confirmation of the selection of a textual element may not be indicated to the user. Alternatively, Steps S1705 and S1707 may be combined such that a textual element is only indicated once it has been finally chosen to be extracted. For example, a textual element may not be indicated until it has been clicked upon and thus the associated words extracted from the displayed text. In yet another embodiment, all the textual elements may be indicated by being presented in a colour different to words of the text which do not form part of a textual element for instance. Subsequently, when a textual element is selected, the words of the selected textual element may be presented in another, different colour.

Although specific approaches to the selection and the indication of textual elements have been given above, these are for example only and in practice any suitable approach may be used. For example, different forms of indication and selection may be used depending on the user interface techniques available at the use display device whilst leaving the underlying functionality unchanged.

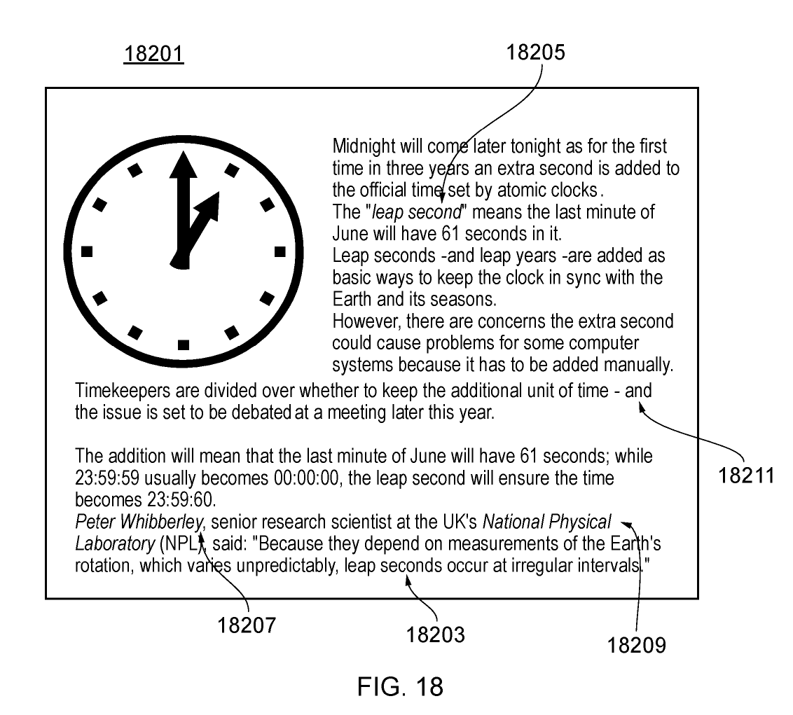

FIG. 18 provides an illustration of an example approach to indicating a textual element in displayed text when a mouse input interface is used. A webpage 18201 is displayed on a user display device where the webpage includes text 18203. As the cursor is moved across the text the various textual elements of the text are indicated to the user, where in FIG. 18 a textual element over which a cursor is placed is displayed in red and in italics. For example, when the cursor is positioned at point 18205 it is positioned over the textual element “leap second”, the words of this textual element are indicated by being displayed in the colour red and italics. Likewise, when the cursor is positioned at positions 18207 and 18209, the words of textual element “Peter Whibberley” and “National Physics Laboratory” are indicated. However, as is explained below in more detail, not all words are eligible to form textual elements. Consequently, when the cursor is positioned at position 18211, the word “and” is not highlighted because it is not eligible to form a textual element, or not by itself. Although the selection of textual elements has been described with respect to a mouse interface, a similar approach could be used for a touch interface. For example, textual elements may be indicated to a user as a drag touch is performed across displayed text but a textual element is selected and entered into a search engine for instance when an individual touch is made with respect to a textual element.

As one can see from FIGS. 17 and 18, embodiments of the present invention convert text from a variety of media sources into text which may be quickly and easily selected and searched by a user with little user interaction. Accordingly, the words of displayed text may act as links to search results based on the words, or as a means to input the words into another program. Embodiments may be particularly advantageous in touch screen applications where conventional approaches to selecting text and inputting it into other programs or search engines are slow and cumbersome and require users to manually determine the words which form textual elements they wish to search and then perform a multistep selection process to select the words. The functionality described with reference to FIGS. 17 and 18 may be referred to as Touch Word due to the ease with which words can be selected and searched using a touch screen interface.

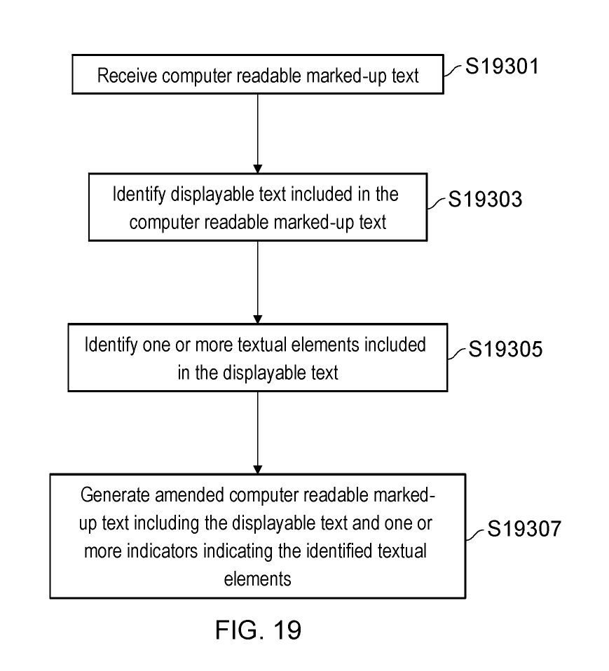

Embodiments of the present invention are described in further detail with respect to FIGS. 19 to 24, where the processing of text from first receipt up to extraction of textual elements and entry in to search engines is described.

In FIG. 19, text is first received at Step S19301 at a computing device such as server or a user device, where the server may be a website host server or an Internet Service Provider (ISP) server, and the user device may be smart phone, laptop computer or a television for example. The text may be part of a webpage, a video stream, a live text feed or any other media which includes text. Preferably the text is in the form of marked-up text so that the displayable text included in the media can be quickly and easily identified without the need for optical character recognition (OCR) or similar process. However, in some embodiments OCR may be performed by the receiving device in order to identify text, where the identified text then converted into a form of marked-up text.

Throughout this description, marked-up text refers to text of any language which includes displayable text and possibly other information or tags which provide presentation or layout information for how to display the displayable text. Examples of marked-up text languages include HyperText Markup Language (HTML) and TeX, and embodiments of the present invention may operate with marked-up text in any of these languages. However, marked-up text may also refer to text included in closed captions or subtitles, or social networks feeds such as Twitter feeds for example. However, throughout this description, example embodiments of the present invention will be predominantly described with reference to marked-up text in HTML due to its ubiquity and comparatively settled implementation.

At Step S19303, the displayable text of the received marked-up text is identified. For example where marked-up text is received in HTML, displayable text may be indicated by the tags such as <p> . . . </P> or <h1} . . . </h1> where the text between these tags is displayable text for a heading or standard paragraph for example. However, many other approaches to identifying displayable text may be used, where the mechanism used to identify displayed text is dependent on the form of the marked-up text.

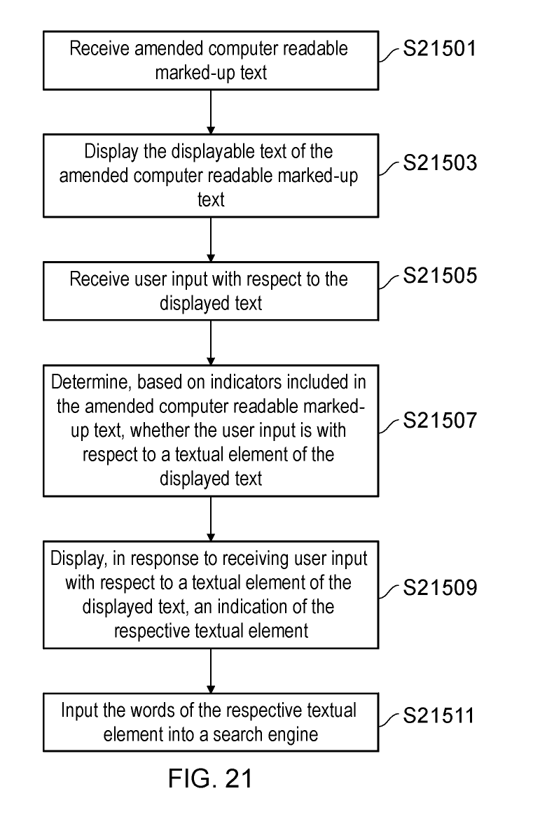

At Step S19305, once the displayable text has been identified, one or more textual elements in the displayable text are then identified, where the textual elements are each formed of one or more words. For example, identified textual elements may include names, places, objects etc. The identification process of the textual elements is described in more detail with reference to FIG. 21.

At Step S19307, amended computer readable marked-up text including the displayable text is generated, where the identified textual elements are indicated in the amended marked-up text. The identified textual elements may be indicated by any appropriate means but preferably they are indicated using tags or equivalent syntax which can be recognised by an appropriately configured computer program but does not affect the presentation of the marked-up text when processed by a conventional computer program. The generated marked-up text may be in the same language as the received marked-up but this may not always be the case. For example, if marked-up text is received in HTML but the displayable text of the HTML file is to be displayed in a different format, it may be appropriate to generate the amended marked-up text in a different language, thus providing interoperability between different formats.

The steps of FIG. 19 may be further explained by referring to an example HTML file which acts as a source of marked-up text. Initially, an HTML file is received, where the HTML file may comprise marked-up text as shown below

<body><h1> Op-Ed Contributor:</h1>

<p>No Justice for Canada's First Peoples. The Truth and Reconciliation Commission has finished its work, and there is every indication that native people will be left, once again, with vague promises.</p><p>New York Times-World News</p></body>

The displayable text of HTML file is then identified by identifying tags such as <p> . . . </P> or <g1} . . . </h1>. Textual elements within the displayable text are then identified and indicated via the introduction of textual element tags, which in the case of HTML may take the form of <t-w> . . . </t-w> where the textual element tags are chosen so that they do not affect the presentation of the displayable text of conventional computer programs i.e. Internet browsers, but are recognised by appropriately configured programs i.e. Internet browser with an appropriate plugin so that the textual elements can be quickly identified. More specifically, the textual elements tags may be legal but unrecognised tags/syntax in the relevant marked-up text language so that the amended marked-up text may still be rendered as the original marked-up text would have been. Accordingly, though <t-w> . . . </t-w> are used as example textual element tags throughout this description, any legal but conventionally unrecognised tags may be used.

A shown below, the textual element tags are introduced around each of the textual elements to generate the amended marked-up text, where each in the present example textual elements are each enclosed by a <t-w> . . . </t-w>pair.

<body><h1><t-w>Op-Ed Contributor</t-w>: </h1><p><t-w>No Justice</t-w> for <t-w>Canada's First Peoples</t-w>. <t-w>The Truth</t-w> and <t-w>Reconciliation Commission</t-w> has <t-w>finished</t-w> its work, and there is every <t-w>indication</t-w> that <t-w>native</t-w> <t-w>people</t-w> will be left, once again, with <t-w>vague</t-w> <t-w>promises</t-w>.</p><p><t-w>New York Times</t-w> <t-w>-World</t-w> <t-w>News</t-w></p></body>

As one can see, the presentation and layout information has been preserved such that the displayable text will be displayed in the same layout as the displayable text of the original HTML text and thus the presence of the textual element tags will not be apparent to the user. However, to appropriately configured programs, each of the textual elements is recognisable and the functionality described above with reference to FIGS. 17 and 18 can be provided.

Although the layout information of the example HTML code has been preserved in the amended marked-up text set out above, the layout information may also be removed such that the amended marked-up text resembles the following <t-w>Op-Ed Contributor</t-w>: <t-w>No Justice</t-w> for <t-w>Canada's First Peoples</t-w>. <t-w>The Truth</t-w>and <t-w>Reconciliation Commission</t-w> has <t-w>finished</t-w> its work, and there is every <t-w>indication</t-w> that <t-w>native</t-w> <t-w>people</t-w> will be left, once again, with <t-w>vague</t-w> <t-w>promises</t-w>. <t-w>New York Times</t-w> <t-w>-World</t-w> <t-w>News</t-w>

The amended marked-up text may be generated by amending the marked-up text in the file that it was originally received i.e. introduce textual element tags. Alternatively, a new file may be generated in which the textual element tags have been introduced into the marked-up text.

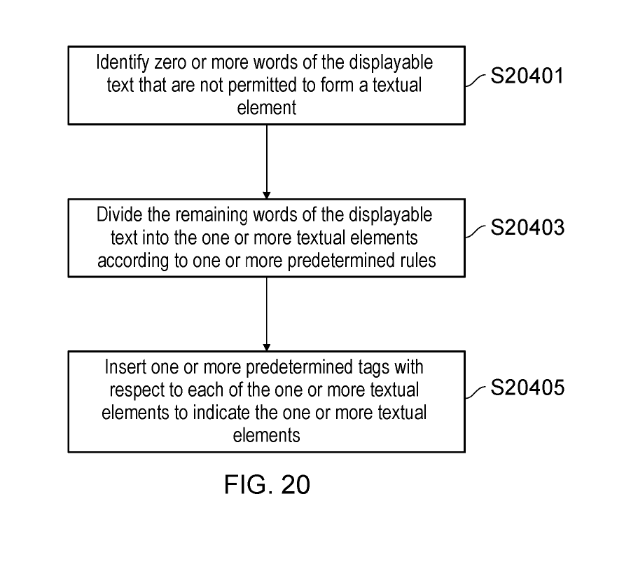

The process of identifying textual elements in displayable text is described with reference to FIG. 20, where, as set out above, may be performed at a user device, a server or any other entity in the transmission path of marked-up text which is to be displayed.

Textual elements are formed from one or more words and are used to easily extract words or sequences of words which a user may which to search or otherwise use. Consequently, particular words or types of word that are unlikely to be of relevance or do not convey meaning should preferably be excluded from inclusion in textual elements. For example it may not be appropriate for conjunctions such as “and”, “for”, “nor”, “but”, “because”, “or”, “when”, or particular adjectives to form part of textual elements.

Consequently, an exclusion list is defined, where the exclusion list includes one or more predetermined words which are not permitted to form textual elements, either exclusively and/or as a component part. An example exclusion list for displayable text which is in English is given below “,as,far,as,as,long,as,as,opposed,to,as,well,as,as,soon,as,according,to,ahead,of,apart,from, as,for,as,of,as,per,as,regards,aside,from,back,to,because,of,close,to,due,to,except,for,far,fro m,in,to,inside,of,instead,of,left,of,near,to,next,to,on,to,out,from,out,of,outside,of,owing,to,prio r,to,pursuant,to,rather,than,regardless,of,right,of,subsequent,to,such,as,thanks,to,that,of,up,t o,where,as,abaft,about,afore,after,against,along,amid,amidst,among,amongst,an,anenst,apr opos,apud,as,aside,astride,at,athwart,atop,barring,before,but,by,concerning,despite,down,d uring,except,excluding,failing,following,for,forenenst,from,given,in,including,inside,into,lest,lik e,mid,midst,minus,modulo,near,next,notwithstanding,of,off,on,onto,opposite,out,outside,over ,pace,past,per,plus,pro,qua,regarding,round,sans,save,since,than,through,throughout,till,tim es,to,toward,towards,unlike,until,unto,up,upon,versus,via,with,within,without,worth,about,abo ve,across,after,again,againstall,almostalone,along,already,also,although,always,among,an, and,another,any,anybody,anyone,anything,anywhere,are,area,areas,around,as,ask,asked,a sking,asks,at,away,b,back,backed,backing,backs,be,became,because,become,becomes,be en,before,began,behind,being,beings,best,better,between,big,both,but,by,came,can,cannot, case,cases,certain,certainly,clear,clearly,come,could,d,did,differ,different,differently,do,does, done,down,down,downed,downing,downs,during,e,each,early,either,end,ended,ending,ends ,enough,even,evenly,ever,every,everybody,everyone,everything,everywhere,f,face,faces,fac t,facts,far,felt,few,find,finds,first,for,four,from,full,fully,further,furthered,furthering,furthers,g,ga ve,general,generally,get,gets,give,given,gives,go,going,good,goods,got,great,greater,greate st,group,grouped,grouping,groups,had,has,have,having,he,her,here,herself,high,high,high,hi gher,highest,him,himself,his,how,however,i,if,important,in,interest,interested,interesting,inter ests,into,is,it,its,itself,j,just,k,keep,keeps,kind,knew,know,known,knows,I,large,largely,last,lat er,latest,least,less,let,lets,like,likely,long,longer,longest,made,make,making,man,many,may, me,member,members,men,might,more,most,mostly,mr,mrs,much,must,my,myself,n,necess ary,need,needed,needing,needs,never,new,new,newer,newest,next,no,nobody,non,noone,n ot,nothing,now,nowhere,number,numbers,o,of,off,often,old,older,oldest,on,once,one,only,op en,opened,opening,opens,or,order,ordered,ordering,orders,other,others,our,out,over,p,part,p arted,parting,parts,per,perhaps,place,places,point,pointed,pointing,points,possible,present,pr esented,presenting,presents,problem,problems,put,puts,q,quite,r,rather,really,right,right,roo m,rooms,s,said,same,saw,say,says,second,seconds,see,seem,seemed,seeming,seems,see s,several,shall,she,should,show,showed,showing,shows,side,sides,since,small,smaller,small est,so,some,somebody,someone,something,somewhere,still,still,such,sure,take,taken,than,t hat,the,their,them,then,there,therefore,these,they,thing,things,think,thinks,this,those,though,t hought,thoughts,three,through,thus,to,today,together,too,took,toward,turn,turned,tuming,turn s,two,u,under,until,up,upon,us,use,used,uses,v,very,w,want,wanted,wanting,wants,was,way, ways,we,well,wells,went,were,what,when,where,whether,which,while,who,whole,whose,why, will,with,within,without,work,worked,working,works,would,x,y,year,years,yet,you,young,youn ger,youngest,your,yours,z,doesn't,you're,we're,they've,wouldn't,i'm,couldn't,there's,i've,-,--, getting,let's,cos,they're,i'll,'i'im,don't,one's,yeah,wasn'it,shes's,isn't,he'll,'i,”

As can be seen from the exclusion list, it is formed from words which do not convey or convey relatively little meaning in themselves or are relatively commonplace such that performing a search related to them would be unlikely to be of interest to a user. For instance, it is unlikely that a user would wish to search for “man” or “room”, thus these words are included in the exclusion list.

Referring to FIG. 20, in Step S20401, once the displayable text has been identified, words which are excluded from textual elements are identified. This identification process may be performed by searching for words in the displayable text which are members of the exclusion list and then ignoring these words when identifying the textual elements.

At Step S20403, once the zero or more words present on the exclusion list have been identified in the displayable text i.e. words which are not permitted to form textual element, the remaining words are divided into textual element according to one or more predetermined rules.

At Step S20405 predetermined tags are then inserted into the marked-up text with respect to the identified textual elements in order to indicate the textual elements.

The one or more predetermined rules used to identify the textual elements may take a number of forms, for example, neighbouring capitalised words may indicate that the words represent a name of a place, person or institution. Therefore, in accordance with one rule neighbouring capitalised words may be defined as a textual element. For instance, with regard to FIG. 18, the words “National Physics Laboratory” may be defined as a textual element. According to another rule, non-capitalised words may be divided up individually. For example, individual words such as a “car” or “patent” may be individually defined as textual elements. In another example, words separated with linking terms may be defined as a textual element. For instance, the term “of” may be classified as a linking element or term, though possibly excluded as a textual element itself, so that words separated by “of” may be defined as a textual element, such that “King of Spain” may be defined as a textual element for example. In yet other examples, words which are commonly found together may also, or alternatively, be defined as a single textual element, such as “mobile phone” or “climate change” for instance.

Although the steps of FIG. 20 have been illustrated and described as being separate, they may also be combined or in some examples skipped. For example, it may not be necessary to have a discrete step of identifying one or more words which are not permitted to form textual elements. Instead at Step S20403, only words not included in the exclusion list may be considered without explicitly identifying each of the words of the displayable text which is included in the exclusion list.

Since an exclusion list is used to identify the words which are not permitted to form textual element as opposed to an inclusion list which defines the words that are permitted to form textual elements, the exclusion list is not required to be as regularly updated since it is unlikely that a word will become so common place that it will no longer be of interest to a user in a short period of time. Conversely, because all words not on the exclusion list may form textual elements, new words which may have not previously existed will automatically be included in textual elements when they first appear in displayable text i.e. enter use. Therefore the process of identifying textual elements may not require adapting when new words enter a language. For example, words which have been newly defined or little used slang words will be automatically eligible to be included in textual elements since they will not be included in the exclusion list. Consequently, by use of an exclusion list, it is not necessary for Touch Word to recognise the word or the meaning of a word in order for textual element including the word to be identified.

Another advantage of identifying textual elements by use of an exclusion list is that it is relatively straightforward to apply the process of FIG. 20 to text in any language. In particular, it is simply required to form an appropriate exclusion list and, in some languages, alter a number of the predetermined rules for dividing up the displayable text into form textual element. For instance, if the purpose of capitalisation differs to that in the English language or capitalisation does not exist in a particular written language the predetermined rules may be required to be changed. An example exclusion list for displayed text in Spanish is given below “,Ya que,ahora,ya que,como,mucho tiempo,ya que,como se opuso,para,como,bueno,como,como,muy pronto,ya que,de acuerdo,para,adelante,de,además,de,como,por,como,por ,como,por,como,cuanto,además,de,la espalda,ya que,de,cerca,debido,excepto,para,lejos,de,en,hacia el interior,de cambio,de,dejó,de,cerca,para,a continuación,en,de,fuera,de,de,fuera,de,gracias,previo a,conforme,bastante,que,independientemente,de,derecha,de,con posterioridad,por ejemplo,ya que,gracias,que,de,encima de,donde,como,a popa,sobre,afore,después,en contra,a lo largo,en medio,en medio de,entre,entre,el,anenst,a propósito,apud,como,además,a caballo,en,de través,en lo alto,bloqueo de Ilamadas,antes,pero,por,en relacion,a pesar de,abajo,durante,salvo,excluyendo,en su defecto,a raiz de,por,forenenst,del,dada,en,incluyendo,en el interior,en,no sea que,al igual que,en medio o medio,menos,en módulo,cerca,al lado,no obstante,de,apagado,encendido,en,frente,de,fuera,sobre,ritmo,mas alla,por,además,favorable,qua,en relacion con,redondo,sin,ahorrar,ya que,a través de,a lo largo,hasta que,los tiempos,hacia,hacia,a diferencia,hasta que,frente,a través de,con,dentro,fuera,vale la pena,alrededor,arriba,al otro lado,después,de nuevo,en contra,todos,casi,por si sola,a lo largo,ya,también,aunque,siempre,entre,una,y,otro,cualquiera,nadie,nadie,nada,en cualquier lugar,son,el área ,áreas,alrededor,como,pregunta,pregunta,pregunta,pregunta,distancia,b,de nuevo,el respaldo,el respaldo,la espalda,ser,se convirtió,pues,llegar a ser,se convierte,sido,antes,comenzaron,detrás,siendo,seres,mejor,mejor,medio,grande,los dos,pero,por,vino,puede,no puede,caso,casos,cierto,desde luego,claro,claro,ven,podrían,d,lo hizo,diferente,distinto,diferente,hacer ,hace,hacer,abajo,abajo,detenido,el tragar,bajadas,durante,e,cada uno,temprano,o bien,al final,terminó,termina,termina,lo suficiente,incluso,de manera uniforme,nunca,todos,todos,todos,todo en todas partes ,f,cara,caras,hecho,hechos,lejos,fieltro,pocos,encontrar,se encuentra,en primer lugar,para,cuatro,de,Lleno,plenamente,aún más,favorecido,promover,promueve,g,dio,en general,por lo general,obtener,consigue,dar,dado,da,va,va,bueno,los bienes,conseguido,grande,mayor,grande,grupo,agrupadas,agrupación,grupos,tuvo,tiene,tie ne,tiene,él,ella,aquí,ella misma,alto,alto,alto,más alto,más alto,él,él,su,cómo,sin embargo,yo,si,importantes,de,interés,interesados,interesante,intereses,en,es,es,es,en sí,j,sólo,mantener,sigue,amable,lo sabía,sabe,conoce,sabe,l,grande,en gran medida,el pasado,más tarde,muy tarde,por lo menos,menos,mucho,vamos,como,probablemente,mucho,más largo,más largo,hecho ,hacer,haciendo,hombre,muchos,pueda,me,miembro,miembros,hombres,alma,más,más,en su mayoria,sr,señora,mucho,debe,a mi,me,n,necesario,necesidad,necesario,necesidad,necesidades ,nunca,nuevo,nuevo,nuevo,el más nuevo,al lado,no,nadie,no,nadie,no,nada,ahora,en ninguna parte,número,nómeros,o,de,fuera de,a menudo,viejo,más viejo,más viejo,en,una vez,uno,solo,abierto,abierto,apertura,abre o,orden,ordenado,pedidos,órdenes,otros,otros,nuestra,fuera,sobre,p,parte,se separaron,separando,partes,por,quizás,lugar,lugares ,punto,señaló,apuntando,puntos,posibles,presentes,presentados,que presentan,regalos,problema,problemas,palabras,puts,q,bastante,r,más bien,de verdad,claro,claro,habitaciones,salas,s,dijo,el mismo,sierra,por ejemplo,dice,segundo,segundos,a ver,al parecer,parecia,al parecer,parece,ve,varios,deberkellá,debe,demostración,mostró,mostrando,espectáculos,lat erales,laterales,ya que,pequeño,más pequeño,el más pequeño,por lo que,algunos,alguien,alguien,algo,en algún lugar,aún,todavía,como,sí,tomar,tomar,de,que,los,las,ellos,entonces,hay,por lo tanto,estos,ellos,cosa,cosas,piensa,piensa,esta,estos,sin embargo,pensamiento,pensamientos,tres,a través de,por lo tanto,a dia de hoy,junto,también,tomó,vuelta,vuelta,vuelta,vueltas,dos,u,bajo,hasta que,hasta ,sobre,nosotros,el uso,utilizado,utiliza,v,muy,w,quiere,quiere,con ganas,deseos,fue,forma,formas,nosotros,asi,pozos,fue,eran,qué,cuándo,dónde,si,lo que ,mientras que,en conjunto,cuyo,¿por qué,voluntad,con,dentro,fuera,trabajo,trabajando,trabajo,obras,lo haría,x,y,años,años,sin embargo,usted,joven,más joven,más joven,su,el suyo,z,no,usted es,que estamos,que hemos,¿no,soy,no podía,no hay,tengo,-,-,el conseguir,vamos,cos,que're,voy,'i'im,no,de uno,si,wasn'it,de los shes,no es,él,'i,”

As well as written language based upon alphabetic scripts, the identification of textual elements will operate for any script for which an exclusion list has been formed. For example, the steps of FIG. 20 are equally applicable to written languages based upon Logographic, Syllabic, Abjad and Abugida scripts.

FIG. 21 illustrates in more detail the steps of displaying and selecting textual elements which were described with reference to FIGS. 17 and 18.

In Step S21501 amended marked-up text generated in accordance with the methods of FIGS. 19 and 20 is received at a user display device. Although the marked-up text may take any form, throughout FIG. 21 marked-up text will assumed to be HTML code which has been received as part of a HTML file.

In Step S21503, the displayable text of the amended marked-up text is displayed on the user display device via the use of an Internet browser for example.

As previously explained, the textual element tags introduced into the amended marked-up text are preferably legal but unrecognised by conventional computer programs such as Internet browsers. Therefore the content of HTML file will be presented normally by a conventional Internet browser even though textual elements tags are present in the file.

However, in accordance with embodiments of the present invention, if the Internet browser is appropriately configured or if an appropriate executable code such as JavaScript program for example is running at the user device, the functionality described with reference to FIGS. 17 and 18 can be provided.

More specifically, when the amended marked-up text is being rendered by an Internet browser for instance, the Internet browser is configured to recognise the indications of the textual elements included in the amended marked-up text and monitor for user interaction with displayed textual elements. Consequently, when user input is received with respect to the displayed text at Step S21505, it is then determined at Step S21507 whether the user input is with respect to a textual element. This may be performed for example by determining the text which has been interacted with and then comparing this text to the indicated textual elements of the amended marked-up text. As previously explained, the user input may take the form of a mouse click, a mouse, roll-over, a touch input or a combination of these inputs for example.

At Step S21509, when it is determined that the user input is with respect to a textual element, an indication of the respective textual element is provided to the user as described with reference to FIG. 18. For example, the indication may be provided to the user when they roll-over or hover the mouse cursor over a textual element or when they confirm they wish to select a textual element by clicking on it.

At Step S21511, the words of the selected textual element are then extracted from the amended marked-up text and input into any chosen function, such as an Internet search engine, local search engine, a website specific search engine, an electronic form or a word processing program for example.

As set out above, Steps S21505 to S21511 will be performed by an appropriately configured program such as an Internet browser, where the functionality may be provided in a number of different ways. For example, as well as introducing textual element tags into the amended marked-up text, if the marked-up text is in HTML, JavaScript which causes the browser to perform the functionality of Steps S21505 to S21511 may also be included in the amended HTML file. Consequently, when the amended HTML file is received, a browser will be configured to perform Steps S21505 to S21511 by virtue of executing the JavaScript. Alternatively, a specific software plugin may be required for a browser such that the browser is configured to recognise the textual element tags in an amended HTML file and subsequently perform Steps S21505 to S21511. In another example, the textual element indicators maybe introduced to the HTML standard such that all browsers compliant with the appropriate version of HTML will be configured to perform the steps of S21505 to S21511. In such an example, the identification and indication of textual elements may be performed by the creator of a webpage such that the source HTML code of a website includes the textual element tags.

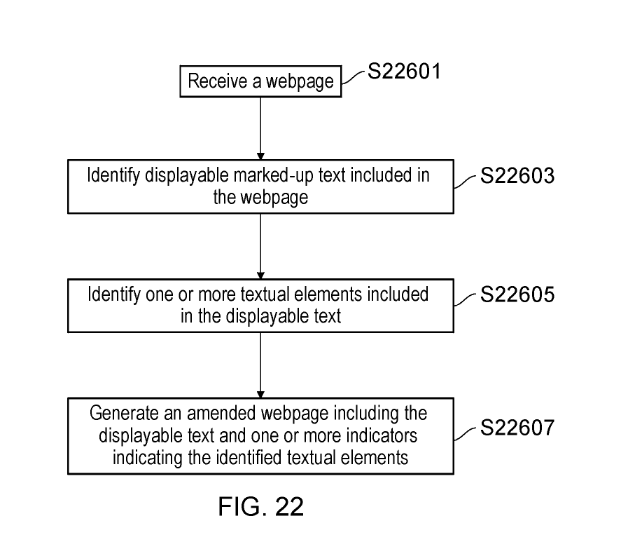

FIG. 22 illustrates the steps which may be performed by a device which generates an amended HTML file corresponding to a webpage.

At Step S22601, the webpage i.e. the HTML file is received.

At Step S22603, the displayable text included in the marked-up text of the HTML file of the webpage is identified.

At Step S22605, one or more textual elements included in the displayed text are identified in accordance with the process described with reference to FIG. 20.

At Step S22607, the identified textual elements are then indicated in the marked-up text via the introduction of textual element tags into the marked-up text in order to generate amended marked-up text, which in the current example may be an amended HTML file. If generated at a sever, the amended HTML file may then be sent to a user device for rendering by an Internet browsers, or if generated at a user device, the amended HTML file may be passed to an Internet browser or passed within an Internet browser for rending and subsequent interaction with by a user.

Although described with reference to a webpage, the process of FIG. 22 may be performed on any marked-up text file of code. For example, if the marked-up text were to be closed captions of a video stream, textual element tags may be inserted into the closed captions such that the video stream itself includes textual element tags. Subsequently, a user may then select textual elements of the closed captions.

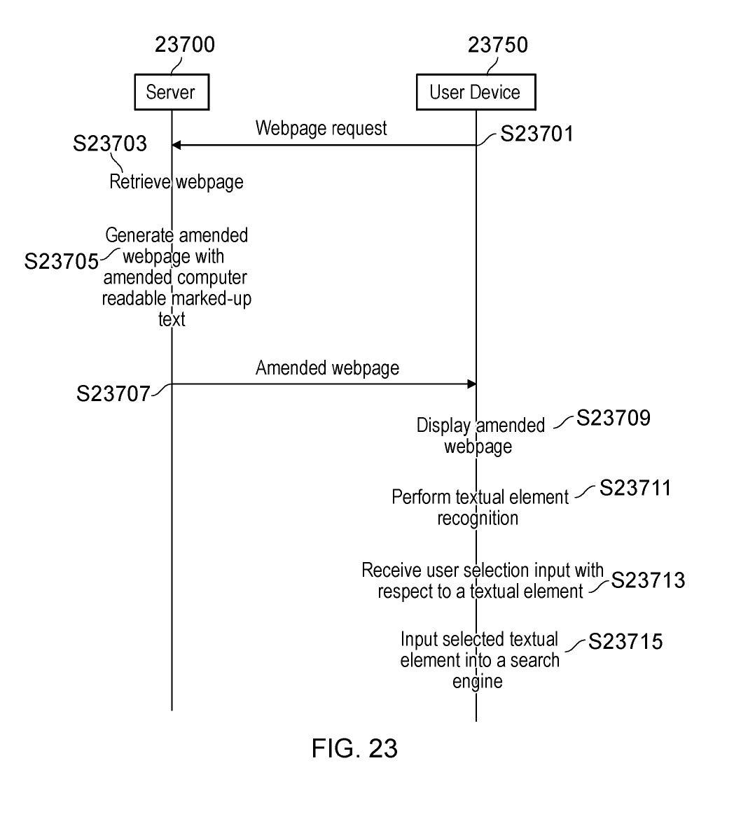

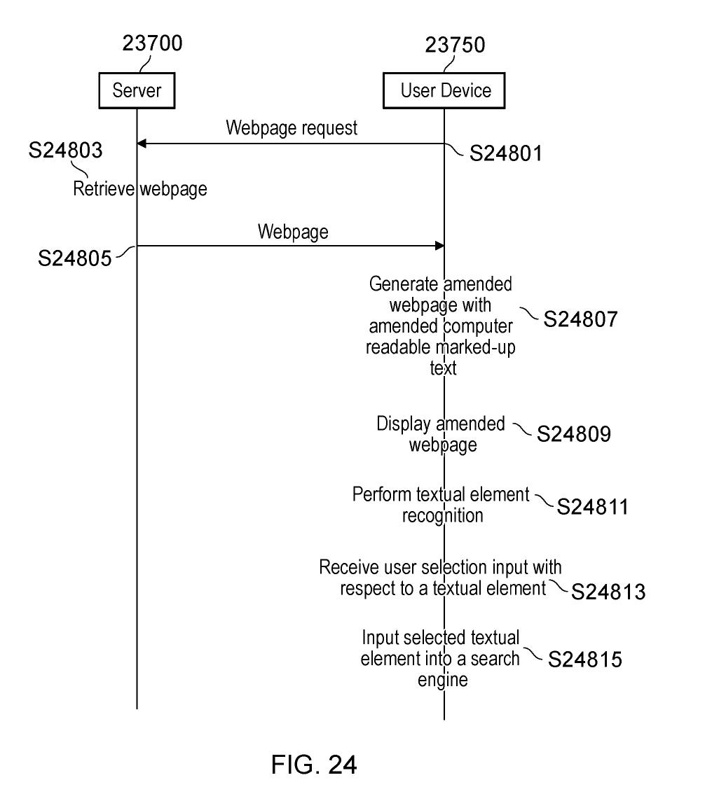

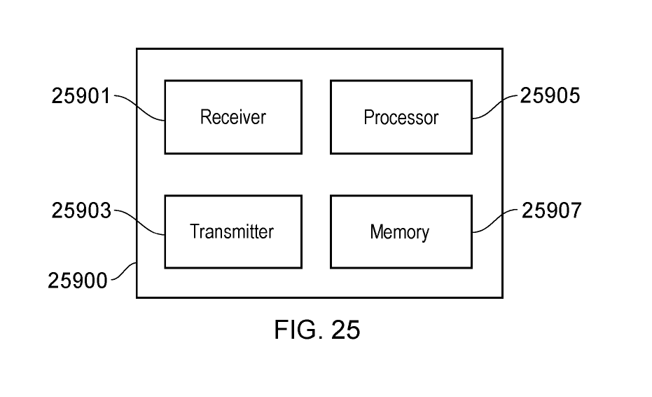

FIGS. 23 and 24 provide illustrations of simplified example communications flows that may take place between a server 23700 and a user device 23750 in embodiments of the present invention where a user is browsing the Internet such that the marked-up text is in the form of an HTML file corresponding to a website.

FIG. 23 illustrates an embodiment where a server performs the generation of the amended marked-up text and thus the amended HTML file.

At Step S23701, a webpage request is made from the user device 23750 to the server 23700, where the server may be an Internet service provider (ISP) associated with the user device, a server hosting the website or an intermediate server.

At Step S23703, upon reception of the webpage request from the user device the server retrieves the HTML file associated with the webpage, where the webpage may be stored at the server or at a different server.

At Step S23705, the server generates an amended HTML file from the retrieved HTML file where textual elements of the marked-up text within the HTML file have been identified and indicated via the introduced of textual element tag. In some embodiments, additional code such as JavaScript may also be inserted into the HTML file to enable computer programs such as Internet browsers at the user device to perform the processing described with reference to FIG. 21.

At Step S23707, the amended HTML file is sent to the user device and the user device, or more precisely a program at the user device, performs steps S23709 to S23715 where these steps, though simplified, are equivalent to the steps of FIG. 21.

At Step S23709, the user device displays the webpage as set out by the received amended HTML file.

At Step S23711, the user device recognises the textual elements by identifying the textual element indicators that were introduced into the amended HTML file.

At Step S23713, the user device receives an input to and/or a selection of a textual element and indicates to the user the textual element with which the input was with respect to.

At Step S23715, the word(s) of the selected textual element are extracted and input to a search engine and a search then performed.

Although in FIG. 23 the generation of the amended marked-up text is performed in response to the user webpage request, the amended marked-up text corresponding to webpages may have been generated at an earlier point in time prior to receiving the user request and stored in memory either at the server or in external storage for retrieval at a later point in time. Furthermore, the steps of S23709 and S23711 may be performed together or in a different order.

FIG. 23 illustrates an embodiment where the user device performs the generation of the amended marked-up text and thus the amended HTML file. The steps of FIG. 24 are similar to those of FIG. 23, where Steps S24801, S24803, and S24809 to S24815 correspond to Steps S23701, S23702 and S23709 to S23715, respectively but the original HTML file is sent to the user device at Step S24805 and the generation of the amended HTML file is performed by the user device such that Step S24807 is performed at the user device.

The functionality of Steps S24807 to S24815 may be provided by a plugin to an Internet browser, where upon reception of an HTML file the plugin generates an amended HTML file which is then passed to the browser as per a conventional HTML file. In this manner the plugin acts as an intermediate layer between the receipt of an HTML file and the display of the HTML file. Such a plugin may provide the textual element selection functionality directly by running in the background when an amended HTML filed is displayed or may introduce JavaScript or code with equivalent functionality into the amended HTML file such that the textual element selection functionality is automatically provided when the amended HTML file is displayed.

As a result of generating the amended HTML file at the user device, no reconfiguration of website host servers or ISP servers is required, thus allowing textual element selection and thus Touch Word to be performed on any received HTML file not just those selected by a server. Furthermore, since an amended HTML file may be generated for each webpage that is requested, if a textual element from a webpage is selected and results in the display of a new webpage, the new webpage will also have been processed according to the embodiments of the present invention technique and thus textual elements of the new webpage will also be able to be selected Consequently, a circular process where the text of all website becomes quickly and easily searchable is formed. A similar result may also be achieved if all HTML files destined for the user device pass through an ISP server and the ISP server generates an amended HTML files for each requested webpage. Since the method illustrated in FIG. 24 may be applied to each received file, the method may be seen to be an additional layer of processing which a received file passes through and introduces the textual element selection functionality.

Preferably, although not exclusively, embodiments of the present invention operate on the displayable text of marked-up text such as HTML file. Therefore the complexity of the textual element identification and the generation of amended marked-up text is relatively low. Consequently, the functionality of the present invention may be introduced into a system with little effect on the speed of the system. For example, if the generation of the amended marked-up text is performed at a user device, there may be little effect on the speed at which webpage is rendered from an HTML file.

As mentioned above, the technique of the touch word aspects of the present invention may operate upon any form of marked-up text or publishable document, and, in some examples, text which has been recognised via OCR. Consequently, it is also possible to apply the present technique to video streams which include marked-up text in the form of subtitles or closed captions for instance. For example, if a television news channel or video streaming service were to include subtitles in their video stream, in accordance with the present invention the textual elements of the subtitles would be searchable by simply selecting them as they are displayed on the screen. For instance, if a news article on “Cuba” is being displayed as a video stream to a laptop user, the user may click upon “Cuba” in the subtitles and an Internet search on “Cuba” may be automatically performed and displayed to the user or presented in another window or tab. Alternatively, a search based upon “Cuba” may be performed on the content of subtitles of other video streams or news feeds, thus presenting the user with one or more related video streams or news feeds.

As stated above, embodiments of the present invention may also operate upon a publishable document. For example, a word processing document effectively contains marked-up text and therefore, if the method of the present invention is appropriately configured to identify the displayable text and insert appropriate indicators of textual elements, and the word processing program is appropriately configured to recognise the textual element indicators, the functionality described with reference to HTML and webpages may be provided for word processing documents.

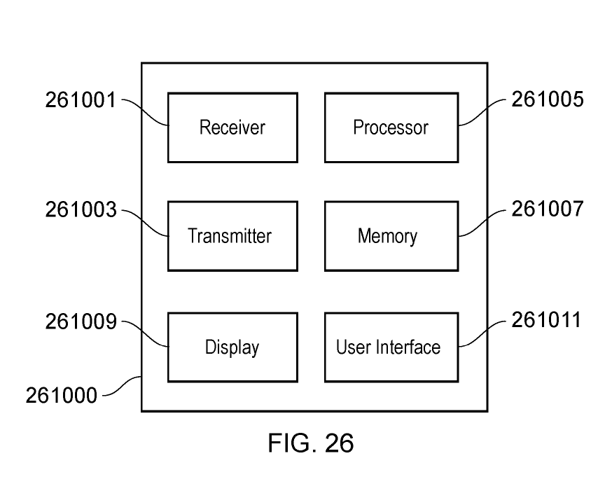

FIG. 25 provides a schematic illustration of a server 25900 operable to perform one or more of the previously described methods and interactions. The server may comprise a receiver 25901, a transmitter 25903, a processor 25905 and a memory 25907. The receiver 25901 is configured to receive marked-up text, where the marked-up text may have been received from an external storage device or the memory 25907. Once the marked-up text has been received, the processor 25905 is configured to perform the one or more of the steps of FIGS. 19, 20, 22 and 23 to generate the amended marked-up text. Upon completion of the generation of the amended marked-up text, the transmitter 25903 may then transmit the amended marked-up text to a client device such as a user device.

FIG. 26 provides a schematic illustration of a user device 261000 operable to perform one or more of the previously described methods and interactions. The user device may comprise a receiver 261001, a transmitter 261003, a processor 261005, a memory 261007, a display 261009 and a user interface 261011.

In a first example where the user device does not generate the amended marked-up text, the receiver 261001 is configured to initially receive the amended marked-up text or file from a server, where the receipt of the amended marked-up text may be in response to request transmitted by the transmitter 261003 to the server. Once received, the amended marked-up text may be stored in the memory 261007, and the processor 261005 controls the display to display displayable text of the amended marked-up text. Once displayed, the processor is configured to detect a user input received through the user interface 261011 to the displayed text, where the user interface may be a touchscreen or a mouse for example. Subsequent to the detection the user input, the processor determines, based on the indicators in the amended marked-up text, whether the received user input is with respect to a textual element of the displayed text, and, in response to receiving user input with respect to a textual element of the displayed text, controls the display to display an indication of the respective textual element. The processor may then also extract the word(s) of the respective textual element and input them into a search engine. As set out above, the steps of determining whether a textual element has been selected, displaying an indication of the selected textual element and insertion of the words of the selected textual element into a search engine may be performed as a result of client-side executable code contained within the amended marked-up text which is executed by the processor. However, alternatively, instead of client-side executable code such as a JavaScript, the processor may execute a program which is stored in the memory to perform equivalent functionality. For example, such an executable program may be a plugin or extension to a browser which is used to render the amended marked-up text.

In a second example, the user device may be configured to perform the method illustrated in FIG. 24 where the user device generates the amended marked-up text. The functional elements of the user device are configured to perform similar functionality as described above, but the receiver 261001 instead receives the un-amended marked-up text from a server and it is from this that the processor then generates the amended marked-up text according to the methods of FIGS. 19 and 20. To perform the generation of the amended marked-up text, the processor may for example execute software which forms part of an Internet browser. Alternatively the processor may execute software which passes the amended marked-up text to a range of different programs for rendering, such as a word processor for instance.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The various embodiments of the present invention may also be implemented via computer executable instructions stored on a computer readable storage medium, such that when executed cause a computer to operate in accordance with any other the aforementioned embodiments.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

It will be also be appreciated that, throughout the description and claims of this specification, language in the general form of “X for Y” (where Y is some action, activity or step and X is some means for carrying out that action, activity or step) encompasses means X adapted or arranged specifically, but not exclusively, to do Y.

1. An automated method of providing search results to a user device, the method comprising:
receiving and/or monitoring at least one signal, the or each signal carrying at least one of text information and audio information;
extracting, from each of a respective plurality of portions of the or each signal, at least a respective quantity of text corresponding to text and/or audio information carried by the respective portion of the signal;
creating a plurality of files, each file corresponding to a respective one of said plurality of portions and comprising said respective quantity of text;
storing said files in at least one database; and
in response to receiving a search request from the user device, said search request including at least one search term or information indicative of said at least one search term:
searching said at least one database to identify at least one matching file, the or each matching file being one of said files containing text corresponding to said at least one search term; and
providing the user device with search results based on said at least one matching file.

2. A method in accordance with claim 1, wherein each said portion corresponds to a respective period of time.

3. A method in accordance with claim 2, wherein each respective period of time has a length in the range 5 to 30 seconds.

4. A method in accordance with claim 3, wherein each respective period of time has a length in the range 10 to 15 seconds.

5. A method in accordance with any one of claims 2 to 4, wherein each respective period of time has substantially the same length.

6. A method in accordance with any preceding claim, wherein said plurality of portions of the or each signal are consecutive portions of the respective signal.

7. A method in accordance with claim 6, wherein said consecutive portions are immediately consecutive portions.

8. A method in accordance with claim 6, wherein each adjacent pair of said consecutive portions are separated by a respective gap.

9. A method in accordance with any preceding claim, wherein said at least one signal comprises at least one signal extracted from a satellite signal.

10. A method in accordance with claim 9, further comprising receiving said satellite signal from a satellite and extracting said at least one extracted signal from said satellite signal.

11. A method in accordance with claim 9 or claim 10, wherein said at least one extracted signal comprises at least one signal comprising, corresponding to, or carrying: a channel, programme, feed, or data stream transmitting, for example broadcasting, news.

12. A method in accordance with any one of claims 9 to 11, wherein said at least one extracted signal comprises a plurality of extracted signals, extracted from at least one satellite signal.

13. A method in accordance with claim 12, wherein said plurality of extracted signals are extracted from a plurality of satellite signals.

14. A method in accordance with claim 13, further comprising receiving said plurality of satellite signals from a plurality of satellites and extracting said plurality of extracted signals from the plurality of satellite signals.

15. A method in accordance with claim 14, wherein receiving said plurality of satellite signals comprises arranging a plurality of satellite signal receivers at a corresponding plurality of locations, each receiver arranged to receive a satellite signal from at least one respective satellite.

16. A method in accordance with any one of claims 9 to 15, further comprising processing the or each extracted signal with a respective server to extract the respective quantities of text and create the respective plurality of files.

17. A method in accordance with any preceding claim, wherein said at least one signal comprises at least one satellite signal.

18. A method in accordance with claim 17, wherein said at least one satellite signal comprises a plurality of satellite signals.

19. A method in accordance with claim 18, wherein said plurality of satellite signals are from a plurality of satellites.

20. A method in accordance with claim 18, further comprising receiving said plurality of satellite signals from a plurality of satellites.

21. A method in accordance with claim 20, wherein receiving said plurality of satellite signals comprises arranging a plurality of satellite signal receivers at a corresponding plurality of locations, each receiver arranged to receive a satellite signal from at least one respective satellite.

22. A method in accordance with any one of claims 17 to 21, further comprising processing the or each satellite signal with a respective processor or processing means to extract the respective quantities of text and create the respective plurality of files.

23. A method in accordance with any preceding claim, wherein said at least one signal comprises at least one terrestrial signal.

24. A method in accordance with claim 23, wherein said at least one terrestrial signal comprises at least one signal: received via terrestrial radio transmission; received via terrestrial optical transmission; received via the internet; received via a website interface; received via SMS; or received via a mobile device application.

25. A method in accordance with claim 24, further comprising receiving said at least one terrestrial signal.

26. A method in accordance with any one of claims 23 to 25, further comprising processing the or each terrestrial signal with a respective processor or processing means to extract the respective quantities of text and create the respective plurality of files.

27. A method in accordance with any preceding claim, wherein said at least one signal comprises, corresponds to, or carries at least one of: a feed; a live feed; a web feed; a channel; a data stream; a live data stream; a broadcast; a live broadcast; a news broadcast; a TV news broadcast; a radio broadcast; a news feed; a radio or TV feed; a data feed; a programme; an internet feed; an RSS feed; a Twitter feed; a video and/or audio feed; a YouTube feed; a social networking feed; a website feed; a Youtube channel.

28. A method in accordance with any preceding claim, wherein said at least one signal carries at least one of: subtitles; subtitle information; programme information; images; image information.

29. A method in accordance with any preceding claim, wherein said at least one signal comprises at least one live signal.

30. A method in accordance with any preceding claim, wherein at least one said portion carries audio information and said extracting, from that portion, of at least a respective quantity of text comprises processing the audio information carried by that portion to generate said respective quantity of text.

31. A method in accordance with claim 30, wherein said portion carrying audio information is a portion of an audio or video signal.

32. A method in accordance with any preceding claim, further comprising storing said portions of the or each signal before said extracting.

33. A method in accordance with claim 32, wherein storing said portions comprises storing each portion in a respective temporary file, and said extracting comprises extracting said respective quantity of text from the respective temporary file.

34. A method in accordance with claim 33, further comprising deleting each temporary file after extracting said respective quantity of text.

35. A method in accordance with any preceding claim, wherein each file (database file) comprises respective time information, said respective time information being indicative of a respective time at which the respective file was created or at which the respective portion was transmitted or at which the respective temporary file was created.

36. A method in accordance with any preceding claim, further comprising identifying a plurality of matching files, and wherein providing the user device with search results comprises providing the user device with a respective search result corresponding to each of said matching files.

37. A method in accordance with claim 36 as depending from claim 35, further comprising ranking the respective search results based at least in part on the respective time information of the respective matching files.

38. A method in accordance with claim 37, wherein said ranking comprises applying a respective age weighting to each search result, the respective age weighting decreasing with increasing age of the respective matching file, said age being or corresponding to a time elapsed since said respective time.

39. A method in accordance with any preceding claim, wherein each said file comprises respective source location information indicative of at least one of:
a location of, or associated with, a source of the respective signal and/or contents; and
a location of, or associated with, a source of text and/or audio information carried by the respective portion of the respective signal.

40. A method in accordance with claim 39, further comprising extracting said respective source location information from the respective signal.

41. A method in accordance with claim 39, further comprising determining said respective source location information from respective identity information indicative of an identity of the respective source.

42. A method in accordance with claim 41, wherein the respective identity information is carried by the respective signal or the respective portion of the respective signal.

43. A method in accordance with claim 41, wherein determining said respective source location information comprises using a database storing source location information indicative of a plurality of source locations and a corresponding plurality of source identities.

44. A method in accordance with any one of claims 39 to 43, wherein said source location information comprises a latitude and a longitude of the respective source location.

45. A method in accordance with any one of claims 39 to 44, wherein said search results are further based on said source location information.

46. A method in accordance with any one of claims 39 to 45, further comprising identifying a plurality of matching files, wherein providing the user device with search results comprises providing the user device with a respective search result corresponding to each of said matching files, and the method further comprising ranking the respective search results based at least in part on said source location information.

47. A method in accordance with claim 46, wherein said search request includes a place name or information indicative of said place name, the method further comprises determining a place location of, or corresponding to, said place name, and said ranking of the respective search results based at least in part on said source location information comprises ranking the search results based at least in part on a distance between the place location and the respective source location.

48. A method in accordance with claim 47, wherein determining said place location comprises using a database storing information indicative of a plurality of place names and a corresponding plurality of place locations.

49. A method in accordance with claim 47 or claim 48, wherein ranking the search results based at least in part on a distance between the place location and the respective source location comprises applying a first distance weighting which decreases the greater the distance between the place location and the respective source location.

50. A method in accordance with claim 49, wherein said first location weighting comprises applying a weighting factor equal, or proportional, to 1/D1, where D1 is the distance between the place location and the respective source location.

51. A method in accordance with any preceding claim, the method further comprising determining a device location of, corresponding to, or associated with, the user device.

52. A method in accordance with claim 51, wherein determining the device location comprises determining the device location from a signal received from the user device.

53. A method in accordance with claim 52, wherein said signal received from the user device consists of or comprises the search request.

54. A method in accordance with claim 51, wherein determining the device location comprises determining the device location from an IP address of the device.

55. A method in accordance with any one of claims 51 to 54, wherein said device location comprises a latitude and a longitude.

56. A method in accordance with any one of claims 51 to 55, wherein said search results are further based on said device location.

57. A method in accordance with any one of claims 51 to 56, further comprising identifying a plurality of matching files, wherein providing the user device with search results comprises providing the user device with a respective search result corresponding to each of said matching files, and the method further comprising ranking the respective search results based at least in part on said device location.

58. A method in accordance with claim 57, further comprising determining a subject location of a subject of said respective quantity of text of each matching file, and wherein said ranking the respective search results based at least in part on said device location comprises ranking the respective search results based at least in part on a distance between the device location and the respective subject location.

59. A method in accordance with claim 58, wherein ranking the respective search results based at least in part on a distance between the device location and the respective subject location comprises applying a second distance weighting factor equal, or proportional, to 1/D2, where D2 is a distance between the device location and the respective subject location.

60. A method in accordance with claim 58 or claim 59, wherein said subject location comprises a latitude and a longitude.

61. A method in accordance with any one of claims 58 to 60, wherein determining said subject location comprises determining said subject location before creating the respective file, and wherein the respective file comprises said subject location or information indicative of said subject location.

62. A method in accordance with any one of claims 58 to 60, wherein determining said subject location comprises determining said subject location after creating the respective file, from the respective quantity of text.

63. A method in accordance with any one of claims 58 to 62, wherein determining said subject location comprises using a database storing information indicative of a plurality of subject locations and a corresponding plurality of words.

64. A method in accordance with any one of claims 51 to 63, as depending from any one of claims 39 to 50, wherein said search results are further based on a distance between the device location and the respective source location.

65. A method in accordance with any one of claims 51 to 64, as depending from any one of claims 39 to 50, comprising identifying a plurality of matching files, wherein providing the user device with search results comprises providing the user device with a respective search result corresponding to each of said matching files, and the method further comprises ranking the respective search results based at least in part on a distance between the device location and the respective source location.

66. A method in accordance with claim 65, wherein ranking the respective search results based at least in part on a distance between the device location and the respective source location comprises applying a third distance weighting factor equal, or proportional, to 1/D3, where D3 is a distance between the device location and the respective source location.

67. A method in accordance with any preceding claim, further comprising receiving said search request.

68. An automated method of generating search results, the method comprising:
receiving and/or monitoring at least one signal, the or each signal carrying at least one of text information and audio information;
extracting, from each of a respective plurality of portions of the or each signal, at least a respective quantity of text corresponding to text and/or audio information carried by the respective portion of the signal;
creating a plurality of files, each file corresponding to a respective one of said plurality of portions and comprising said respective quantity of text;
storing said files in at least one database; and
in response to receiving a search request including at least one search term or information indicative of said at least one search term:
searching said at least one database to identify at least one matching file, the or each matching file being one of said files containing text corresponding to said at least one search term; and
generating search results based on said at least one matching file.

69. A method in accordance with claim 68, comprising identifying a plurality of matching files, and wherein generating said search results comprises generating a respective search result corresponding to each matching file.

70. A method in accordance with claim 69, further comprising ranking the respective search results.

71. A method in accordance with claim 70, wherein said ranking comprises ranking the respective search results according to at least one of:
time information indicative of a time associated with the respective file;
source location information indicative of a location of, corresponding to, or associated with, a source of the respective signal or respective portion and/or its contents;
user device location information indicative of a location of, corresponding to, or associated with, a user device originating said search request; and
subject location information indicative of a location of, corresponding to, or associated with, a subject of said respective quantity of text.

72. A method in accordance with any one of claims 68 to 71, further comprising transmitting said search results.

73. A method in accordance with claim 72, wherein said search request is a search request from a user device, and said transmitting comprises transmitting said search results to, or for reception by, said user device.

74. A method in accordance with claim 73, comprising providing said search results to the user device.

75. An automated method of generating search results, the method comprising, in response to receiving a search request including at least one search term or information indicative of said at least one search term:
searching at least one database to identify at least one matching file, said at least one database comprising a plurality of files each comprising at least a respective quantity of text and respective time information indicative of a time of, associated with, or corresponding to creation of the respective file, the or each matching file being one of said files containing text corresponding to said at least one search term; and
generating search results based on said at least one matching file.

76. A method in accordance with claim 75, comprising identifying a plurality of matching files, and wherein generating said search results comprises generating a respective search result corresponding to each matching file.

77. A method in accordance with claim 76, further comprising ranking the respective search results.

78. A method in accordance with claim 77, wherein said ranking comprises ranking the respective search results according to at least one of:
said time information;
source location information indicative of a location of, corresponding to, or associated with, a source of the respective file, a signal from which the file was derived, and/or its contents;
user device location information indicative of a location of, corresponding to, or associated with, a user device originating said search request; and
subject location information indicative of a location of, corresponding to, or associated with, a subject of said respective quantity of text.

79. A method in accordance with claim 78, wherein each of the plurality of files comprises respective source location information.

80. A method in accordance with claim 78 or claim 79, wherein each of the plurality of files comprises respective subject location information.

81. A method in accordance with any one of claims 75 to 80, further comprising receiving said search request from a user device.

82. A method in accordance with claim 81, further comprising transmitting or providing said search results to the user device.

83. An automated method of creating, maintaining, updating, or managing a computer-searchable database, the method comprising:
receiving and/or monitoring at least one signal, the or each signal carrying at least one of text information and audio information;
extracting, from each of a respective plurality of portions of the or each signal, at least a respective quantity of text corresponding to text and/or audio information carried by the respective portion of the signal;
creating a plurality of files, each file corresponding to a respective one of said plurality of portions and comprising said respective quantity of text; and
storing said files in at least one database.

84. A method in accordance with claim 83, further comprising storing said portions of the or each signal before said extracting.

85. A method in accordance with claim 84, wherein storing said portions comprises storing each portion in a respective temporary file, and said extracting comprises extracting said respective quantity of text from the respective temporary file.

86. A method in accordance with claim 85, further comprising deleting each temporary file after extracting said respective quantity of text.

87. A method in accordance with any one of claims 83 to 86, wherein each file comprises respective time information, said respective time information being indicative of a respective time at which the respective file was created or at which the respective portion was transmitted or at which the respective temporary file was created.

88. A method in accordance with any one of claims 83 to 87, wherein each file further comprises at least one of:
respective source location information indicative of a location of, associated with, or corresponding to, a source of the respective signal, respective portion, and/or its contents; and
respective subject location information indicative of a location of, corresponding to, or associated with, a subject of said respective quantity of text.

89. An automated method of providing search results to a user device, the method comprising:
receiving a search request from a user device, the search request comprising information indicative of at least one search term and a location of the user device;
searching at least one information source for search results based at least in part on the at least one search term and the location of the user device; and
providing said search results to the user device.

90. An automated method of providing search results to a user device, the method comprising:
receiving a search request from a user device, the search request comprising information indicative of at least one search term;
determining a location of the user device;
searching at least one information source for search results based at least in part on the at least one search term and the location of the user device; and
providing said search results to the user device.

91. An automated method of providing search results to a user device, the method comprising:
receiving a search request from a user device, the search request comprising information indicative of at least one search term;
searching at least one information source for search results based at least in part on the at least one search term and an age of the information; and
providing said search results to the user device.

92. An automated method of providing search results to a user device, the method comprising:
receiving a search request from a user device, the search request comprising information indicative of at least one search term;
searching at least one information source for search results based at least in part on the at least one search term and a location associated with the search results; and
providing said search results to the user device.

93. An automated method of generating search results, the method comprising, in response to receiving a search request including at least one search term or information indicative of said at least one search term:
searching at least one database storing a plurality of files each comprising at least a respective quantity of text and respective time information indicative of an age of the respective file; and
generating search results based on said at least one search term and said time information.

94. A method in accordance with claim 93, wherein said search results are further based on at least one of:
source location information indicative of a location of, corresponding to, or associated with, a source of the respective file, a signal from which the file was derived, and/or its contents;
user device location information indicative of a location of, corresponding to, or associated with, a user device originating said search request; and
subject location information indicative of a location of, corresponding to, or associated with, a subject of said respective quantity of text.

95. A method in accordance with any preceding claim, wherein said extracting further comprises extracting a respective image or respective image data from at least one said portion, the respective image or respective image data then being comprised in the respective file.

96. Apparatus adapted to implement a method in accordance with any preceding claim.

97. Apparatus operable to provide search results to a user device, the system comprising:
signal receiving and/or monitoring means arranged to receive and/or monitor at least one signal carrying at least one of text information and audio information;
extraction means arranged in communication with the signal receiving and/or monitoring means and further arranged to extract, from each of a plurality of portions of the or each signal, at least a respective quantity of text corresponding to text and/or audio information carried by the respective portion of the signal;
file creating means arranged in communication with the extraction means and further arranged to create a plurality of files, each file corresponding to a respective one of said plurality of portions and comprising said respective quantity of text;
file storage means arranged in communication with the file creating means and arranged to store said files; and
search request processing means arranged to: receive a search request from the user device, said search request including at least one search term or information indicative of said at least one search term; search said file storage means for at least one matching file, the or each matching file being one of said files containing text corresponding to said at least one search term; and transmit search results to the user equipment, said search results being based on said at least one matching file.

98. Apparatus operable to generate search results automatically in response to receiving a search request, the apparatus comprising:
signal receiving and/or monitoring means arranged to receive and/or monitor at least one signal carrying at least one of text information and audio information;
extraction means arranged in communication with the signal receiving and/or monitoring means and further arranged to extract, from each of a plurality of portions of the or each signal, at least a respective quantity of text corresponding to text and/or audio information carried by the respective portion of the signal;
file creating means arranged in communication with the extraction means and further arranged to create a plurality of files, each file corresponding to a respective one of said plurality of portions and comprising said respective quantity of text;
file storage means arranged in communication with the file creating means and arranged to store said files; and
search request processing means arranged to: receive a search request, said search request including at least one search term or information indicative of said at least one search term; search said file storage means for at least one matching file, the or each matching file being one of said files containing text corresponding to said at least one search term; and generate search results based on said at least one matching file.

99. Apparatus in accordance with claim 97 or claim 98, wherein said at least one signal comprises at least one satellite signal and the signal receiving and/or monitoring means comprises at least one satellite receiver arranged to receive at least one said satellite signal.

100. Apparatus in accordance with claim 99, wherein the signal receiving and/or monitoring means comprises a plurality of satellite signal receivers at a corresponding plurality of locations, each receiver arranged to receive a satellite signal from at least one respective satellite.

101. Apparatus in accordance with claim 100, wherein said plurality of satellite signal receivers comprises at least four satellite signal receivers distributed around the world.

102. A method in accordance with any one of claims 99 to 101, wherein the text extraction means comprises a respective processor arranged to extract the respective quantities of text from each received satellite signal, and optionally create the respective plurality of files.

103. Apparatus in accordance with any one of claims 97 to 102, wherein said at least one signal comprises at least one terrestrial signal, and the signal receiving and/or monitoring means comprises at least one terrestrial signal receiver arranged to receive said at least one terrestrial signal.

104. Apparatus in accordance with claim 103, wherein the extraction means comprises a respective processor arranged to extract the respective quantities of text from each received terrestrial signal, and optionally create the respective plurality of files.

105. A server adapted to provide at least one of said signal receiving and/or monitoring means, extraction means, file creating means, file storage means, and search request processing means of apparatus in accordance with any one of claims 97 to 104.

106. Software arranged such that, when executed by a user device, the user device provides a user interface for interacting with a method, apparatus, or system in accordance with any preceding claim.

107. Software in accordance with claim 106, further arranged such the user device obtains and transmits location information indicative of a location of the user device.

108. Software arranged such that, when executed by a user device, the user device provides a user interface for inputting a search request comprising at least one search term, and transmits a search request message, containing said search terms or information indicative of said search terms, for reception by a search engine, in response to a user inputting said search request, said software being further arranged such that the user device obtains location information indicative of a location of said user device and transmits said location information for reception by said search engine.

109. Software in accordance with claim 108, arranged such that the user device transmits said location information in said search request message.

110. Software in accordance with claim 108 or claim 109, arranged such that the user device obtains said location information in response to a user inputting said search request.

111. A user device on which is installed software in accordance with any one of claims 106 to 110.

112. A database created, updated, maintained, and/or managed by a method in accordance with any preceding claim.

113. A computer-searchable database storing a plurality of files, each file comprising a respective quantity of text, or information indicative of said quantity of text, and at least one of:
respective time information indicative of a respective time at which the respective file was created;
respective source location information indicative of a location of, associated with, or corresponding to, a source of a respective signal or signal portion from which the respective quantity of text was extracted; and
respective subject location information indicative of a location of, corresponding to, or associated with, a subject of said respective quantity of text.

114. A search engine arranged to implement a method in accordance with any preceding claim.

115. Apparatus, a method, a database, a computer program, software, a server, user device, or a search engine substantially as hereinbefore described with reference to the accompanying figures.
